(19) United States
(12) Patent Application Publication
(10) Pub. No.: US 2014/0093281 A1
(43) Pub. Date: Apr. 3, 2014

(54) ELECTROPHOTOGRAPHIC PHOTOSENSITIVE MEMBER, PROCESS CARTRIDGE, AND ELECTROPHOTOGRAPHIC APPARATUS

(71) Applicants: Koji Takahashi, Kashiwa-shi (JP); Hiroki Uematsu, Mishima-shi (JP); Takahiro Mitsui, Kawasaki-shi (JP); Yasuhiro Kawai, Abiko-shi (JP); Tsutomu Nishida, Mishima-shi (JP); Hideki Ogawa, Moriya-shi (JP)

(72) Inventors: Koji Takahashi, Kashiwa-shi (JP); Hiroki Uematsu, Mishima-shi (JP); Takahiro Mitsui, Kawasaki-shi (JP); Yasuhiro Kawai, Abiko-shi (JP); Tsutomu Nishida, Mishima-shi (JP); Hideki Ogawa, Moriya-shi (JP)

(73) Assignee: CANON KABUSHIKI KAISHA, Tokyo (JP)

(21) Appl. No.: 14/117,000

(22) PCT Filed: May 28, 2012
(86) PCT No.: PCT/JP2012/064339

§ 371 Date: Nov. 11, 2013

(30) Foreign Application Priority Data
May 31, 2011 (JP) 2011-122748
Feb. 29, 2012 (JP) 2012-043118
Mar. 2, 2012 (JP) PCT/JP2012/056046
May 24, 2012 (JP) 2012-118554

(51) Int. Cl. G03G 15/00

(52) U.S. Cl. CPC G03G 15/75
USPC 399/159

(57) ABSTRACT

An electrophotographic photosensitive member in which image deletion is hardly produced, and a process cartridge and electrophotographic apparatus having the electrophotographic photosensitive member are provided. For this, a surface of the electrophotographic photosensitive member includes a plurality of depressed portions and a portion other than the depressed portions, each of the depressed portions having a depth of 0.5 to 5 μm and an opening longest diameter of 20 to 80 μm; when a 500 μm×500 μm square region is disposed in an arbitrary position of the surface of the electrophotographic photosensitive member, the area of the depressed portions in the 500 μm×500 μm square region is from 10000 to 90000 μm², and the area of a flat part contained in the portion other than the depressed portions is from 80000 to 240000 μm².

### TECHNICAL FIELD

The present invention relates to an electrophotographic photosensitive member, a process cartridge, and an electrophotographic apparatus.

### BACKGROUND ART

Electrical and mechanical external forces such as charging and cleaning are applied to the surface of an electrophotographic photosensitive member. Thus, durability to these external forces (such as resistance to wear) is demanded of the electrophotographic photosensitive member.

To meet the demand, techniques for improvement are used in the related art, for example, use of a resin having high resistance to wear (such as curable resins) in the surface layer of the electrophotographic photosensitive member.

On the other hand, examples of problems caused by increasing the resistance to wear of the surface of the electrophotographic photosensitive member include image deletion. It is thought that the image deletion is caused by deterioration of a material used for the surface layer of the electrophotographic photosensitive member by an oxidizing gas such as ozone and nitrogen oxides produced by charging the surface of the electrophotographic photosensitive member, or reduction in resistance of the surface of the electrophotographic photosensitive member due to the adsorption of moisture. As the resistance to wear of the surface of the electrophotographic photosensitive member is higher, it is more difficult to refresh the surface of the electrophotographic photosensitive member (remove substances that cause the image deletion such as the deteriorated material and the adsorbed moisture), and the image deletion is more likely to be produced.

As a technique for improving the image deletion, PTL 1 discloses a technique for forming dimple-like depressed portions on the surface of an electrophotographic photosensitive member by dry blasting or wet honing. According to PTL 1, a plurality of dimple-like depressed portions is provided on the surface of the electrophotographic photosensitive member; thereby, the image deletion can be suppressed from the initial stage to approximately 5000 sheets.

PTL 2 discloses a technique for suppressing image deletion, in which 76 numbers or more and 1,000 numbers or less per 100 μm×100 μm square of depressed portions having an opening average longitudinal diameter of no less than 3.0 μm and not more than 14.0 μm is provided on the surface of an electrophotographic photosensitive member to keep high dot reproductivity from the initial stage to approximately 50000 sheets even under a high temperature and highly humid environment.

PTL 3 discloses an imaging member having a patterning surface.

### CITATION LIST

### Patent Literature

PTL 1: Japanese Patent No. 3938209
PTL 2: Japanese Patent Application Laid-Open No. 2007-233355
PTL 3: Japanese Patent Application Laid-Open No. 2011-22578

### SUMMARY OF INVENTION

### Technical Problem

However, the technique disclosed in PTL 1 suppresses only the image deletion at a relatively initial stage. Additionally, the technique has room for improvement in the image deletion remarkably produced in the vicinity of a charging apparatus. Moreover, the technique has room for improvement in the image deletion immediately after start of the electrophotographic apparatus, which is often produced in the case where the electrophotographic apparatus is left under a high temperature and highly humid environment for several days.

The technique disclosed in PTL 2 also has room for improvement in the image deletion remarkably produced in the vicinity of the charging apparatus, and in the image deletion immediately after start of the electrophotographic apparatus, which is often produced in the case where the electrophotographic apparatus is left under a high temperature and highly humid environment for several days.

Even by use of the technique disclosed in PTL 3, a sufficient effect of suppressing the image deletion produced in the vicinity of the charging apparatus and the image deletion immediately after start of the electrophotographic apparatus, which is often produced in the case where the electrophotographic apparatus is left under a high temperature and highly humid environment for several days, has not been obtained.

An object of the present invention is to provide an electrophotographic photosensitive member in which image deletion is hardly produced, and a process cartridge and electrophotographic apparatus that have the electrophotographic photosensitive member.

### Solution to Problem

The present invention is an electrophotographic photosensitive member including a support and a photosensitive layer formed on the support, wherein a surface of the electrophotographic photosensitive member includes a plurality of depressed portions and a portion other than the depressed portions, each of the depressed portions having a depth of 0.5 to 5 μm and an opening longest diameter of 20 to 80 μm, and when a 500 μm×500 μm square region is disposed in an arbitrary position of the surface of the electrophotographic photosensitive member, an area of the depressed portions in the 500 μm×500 μm square region is from 10000 to 90000 μm², and an area of a flat part contained in the portion other than the depressed portions is from 80000 to 240000 μm².

Moreover, the present invention is an electrophotographic photosensitive member including a support and a photosensitive layer formed on the support, wherein at least a contact area with a cleaning member includes a plurality of depressed portions and a portion other than the depressed portions, each of the depressed portions having a depth of 0.5 to 5 μm and an opening longest diameter of 20 to 80 μm, and when a 500 μm×500 μm square region is disposed in an arbitrary position of the contact area with the cleaning member, an area of the depressed portions in the 500 μm×500 μm square region is from 10000 to 90000 μm², and an area of a flat part contained in the portion other than the depressed portions is from 80000 to 240000 μm².

Moreover, the present invention is a process cartridge being detachably attachable to a main body of an electrophotographic apparatus including the electrophotographic photosensitive member, and a cleaning unit having a cleaning member disposed in contact with the electrophotographic photosensitive member.

Moreover, the present invention is an electrophotographic apparatus including the electrophotographic photosensitive member, a charging unit, an exposure unit, a developing unit, a transfer unit, and a cleaning unit having a cleaning member disposed in contact with the electrophotographic photosensitive member.

### Advantageous Effects of Invention

According to the present invention, an electrophotographic photosensitive member in which image deletion is hardly produced, and a process cartridge and electrophotographic apparatus having the electrophotographic photosensitive member can be provided.

Further features of the present invention will become apparent from the following description of exemplary embodiments with reference to the attached drawings.

### BRIEF DESCRIPTION OF DRAWINGS

FIGS. 1A and 1B are drawings schematically illustrating the relationship among a reference surface, a flat part, a depressed portion, and the like.

FIGS. 2A, 2B, 2C, 2D, 2E, 2F and 2G are drawings illustrating a shape of an opening of a depressed portion in the surface of an electrophotographic photosensitive member.

FIGS. 3A, 3B, 3C, 3D, 3E, 3F and 3G are drawings illustrating an example of a shape of a cross section of a depressed portion in the surface of an electrophotographic photosensitive member.

FIG. 4 is a drawing illustrating an example of an abut pressure shape transfer machine for forming depressed portions on the surface of an electrophotographic photosensitive member.

FIG. 5 is a drawing illustrating an example of an electrophotographic apparatus including a process cartridge having the electrophotographic photosensitive member according to the present invention.

FIGS. 6A, 6B, 6C and 6D are drawings illustrating a mold used in Production Example of the electrophotographic photosensitive member.

FIG. 7 is a drawing illustrating an example of fitting.

FIGS. 8A and 8B are drawings illustrating the results of observation of the cross section in the vicinity of the surface layer of the electrophotographic photosensitive member.

FIG. 9 is a drawing illustrating an example of a dry blasting apparatus.

FIG. 10 is a drawing for describing a narrow area.

### DESCRIPTION OF EMBODIMENTS

Preferred embodiments of the present invention will now be described in detail in accordance with the accompanying drawings.

In the present invention, the area of the flat part has a larger proportion in the surface of the electrophotographic photosensitive member than that in PTL 1. In the case where dimple-like depressed portions are provided on the surface of the electrophotographic photosensitive member using dry blasting or wet honing, particles collide against the surface of the electrophotographic photosensitive member at random. For this reason, of the portion other than the depressed portions, the proportion of the area of the flat part is extremely reduced.

Moreover, in the present invention, the area of the flat part has a larger proportion in the surface of the electrophotographic photosensitive member than that in PTL 3 as well as in PTL 1.

Moreover, in the present invention, the depressed portions having a larger opening longest diameter (longer diameter) are provided in the surface of the electrophotographic photosensitive member, and the ratio of the area of the depressed portions is smaller than that in the case of PTL 2.

In the present invention, the area of the depressed portion is the area of the depressed portion when the surface of the electrophotographic photosensitive member is observed from above, and means the area of an opening of the depressed portion. The flat part and a projected portion are defined in the same manner.

As a result of research by the present inventors, it was found out that if depressed portions having a large opening longest diameter (Preferably, depressed portions having a large opening shortest diameter as well as a large opening longest diameter) are loosely disposed on the surface of the electrophotographic photosensitive member, and particularly a large area of the flat part of the portion other than the depressed portions is provided, the effect of suppressing image deletion is significantly improved.

The depressed portions having a large opening longest diameter are loosely disposed. Thereby, chattering of a cleaning blade is appropriately suppressed to produce a stable friction state between the surface of the electrophotographic photosensitive member and the cleaning blade. Following this, the pressure of the cleaning blade against the depressed portion becomes relatively lower, and the pressure thereof against the portion other than the depressed portions becomes relatively higher. Among the portions other than the depressed portions to which a higher pressure is applied, the proportion of the flat part is increased, in which the surface of the electrophotographic photosensitive member is easily refreshed efficiently. Thereby, the image deletion-causing substances adhering to the surface of the electrophotographic photosensitive member are easy to remove. The present inventors think that such a mechanism significantly improves the effect of suppressing the image deletion.

Specifically, on the surface of the electrophotographic photosensitive member according to the present invention, a plurality of depressed portions is provided, each of the depressed portions having a depth of 0.5 to 5 μm and an opening longest diameter of 20 to 80 μm. Hereinafter, the plurality of depressed portions having a depth of 0.5 to 5 μm and an opening longest diameter of 20 to 80 μm is referred to as a “specific depressed portion” in some cases. In the present invention, when the 500 μm×500 μm square region (area of 250000 μm²) is disposed in an arbitrary position of the surface of the electrophotographic photosensitive member (that is, the 500 μm×500 μm square region is disposed wherever on the surface of the electrophotographic photosensitive member), the specific depressed portions are provided on the surface of the electrophotographic photosensitive member such that the area of the specific depressed portions in the 500 μm×500 μm square region is from 10000 to 90000 μm². In the present invention, when the 500 μm×500 μm square region (area of 250000 μm²) is disposed in an arbitrary position of the contact region between the cleaning member and the surface of the electrophotographic photosensitive member (that is, the 500 μm×500 μm square region is disposed wherever on the contact region between the cleaning member and the surface of the electrophotographic photosensitive member), the specific depressed portions are provided on the surface of the electrophotographic photosensitive member such that the area of the specific depressed portions in the 500 μm×500 μm square region is from 10000 to 90000 μm². In the case where the surface of the electrophotographic photosensitive member has a curved surface (for example, in the case where the electrophotographic photosensitive member is cylindrical, the surface (circumferential surface) of the electrophotographic photosensitive member has a surface curved in the circumferential direction), “disposing the 500 μm×500 μm square region (area of 250000 μm²) in an arbitrary position of the surface of the electrophotographic photosensitive member” means that when the curved surface is corrected to a plane, a region that is a square in the plane (area of 250000 μm²) is disposed in an arbitrary position of the surface of the electrophotographic photosensitive member. Similarly, “disposing the 500 μm×500 μm square region (area of 250000 μm²) in an arbitrary position of the contact region between the cleaning member and the surface of the electrophotographic photosensitive member” means that when the curved surface is corrected to a plane, a region that is a square in the plane (area of 250000 μm²) is disposed in an arbitrary position of the contact region between the cleaning member and the surface of the electrophotographic photosensitive member. A 10 μm×10 μm square region described later is defined in the same manner.

Moreover, in addition to the specific depressed portion, the flat part is provided on the surface of the electrophotographic photosensitive member according to the present invention. In the present invention, when the 500 μm×500 μm square region is disposed in an arbitrary position of the surface of the electrophotographic photosensitive member, the flat part is provided on the surface of the electrophotographic photosensitive member such that the area of the flat part in the 500 μm×500 μm square region is from 80000 to 240000 μm².

The specific depressed portion and the flat part on the surface of the electrophotographic photosensitive member can be observed using a microscope such as a laser microscope, an optical microscope, an electron microscope, and an atomic force microscope.

As the laser microscope, the followings can be used, for example: Ultra-high Depth Shape Measurement Microscope VK-8550, Ultra-high Depth Shape Measurement Microscope VK-9000, Ultra-high Depth Shape Measurement Microscopes VK-9500 and VK-X200 made by Keyence Corporation; Surface Shape Measurement System Surface Explorer SX-520DR type made by Ryoka Systems Inc.; Confocal Scanning Laser Microscope OLS3000 made by Olympus Corporation; and Real Color Confocal Microscope OPTELICS C130 made by Lasertec Corporation.

As the optical microscope, the followings can be used, for example: Digital Microscope VHX-500, Digital Microscope VHX-200 made by Keyence Corporation; and 3D Digital Microscope VC-7700 made by OMRON Corporation.

As the electron microscope, the followings can be used, for example: 3D Real Surface View Microscope VE-9800, 3D Real Surface View Microscope VE-8800 made by Keyence Corporation; Scanning Electron Microscope Conventional/Variable Pressure SEM made by SII NanoTechnology Inc.; and Scanning Electron Microscope SUPERSCAN SS-550 made by SHIMADZU Corporation.

As the atomic force microscope, the followings can be used, for example: Nanoscale Hybrid Microscope VN-8000 made by Keyence Corporation; Scanning Probe Microscope NanoNavi Station made by SII NanoTechnology Inc.; and Scanning Probe Microscope SPM-9600 made by SHIMADZU Corporation.

The 500 μm×500 μm square region and the 10 μm×10 μm square region described later may be observed at a magnification such that the 500 μm×500 μm square region is included in the field; or the square region may be partially observed at a higher magnification, and a plurality of partial images may be combined using software.

Determination (definition) of the specific depressed portion and the flat part in the 500 μm×500 μm square region will be described.

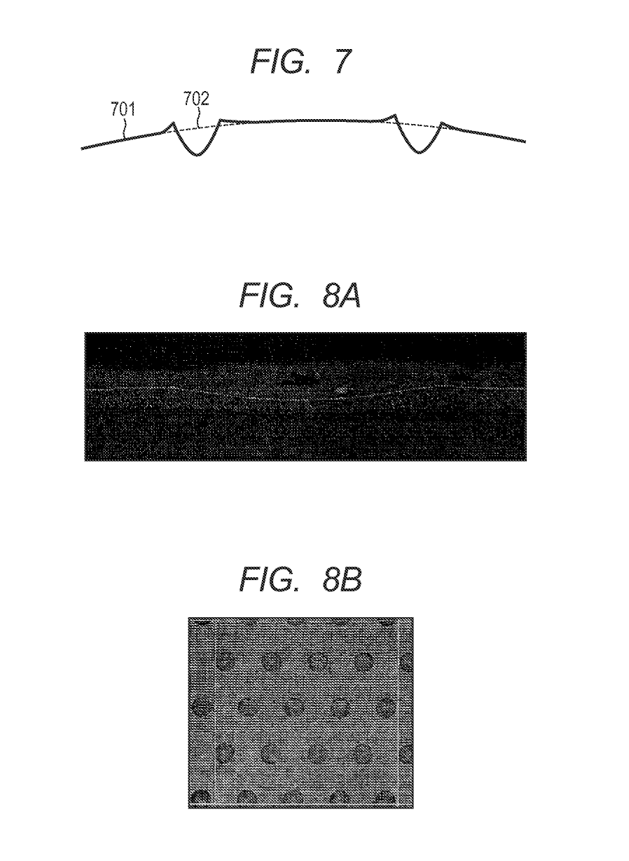

First, the surface of the electrophotographic photosensitive member is enlarged and observed by a microscope. In the case where the surface (circumferential surface) of the electrophotographic photosensitive member has a surface curved in the circumferential direction, for example, in the case where the electrophotographic photosensitive member is cylindrical, the cross-sectional profile of the curved surface is extracted, a curve (an arc if the electrophotographic photosensitive member is cylindrical) is fitted. FIG. 7 illustrates an example of fitting. The example illustrated in FIG. 7 is an example in which the electrophotographic photosensitive member is cylindrical. In FIG. 7, a solid line 701 indicates the cross-sectional profile of the surface (curved surface) of the electrophotographic photosensitive member, and a dashed line 702 indicates a curve fitted to the cross-sectional profile 701. The cross-sectional profile 701 is corrected such that the curve 702 becomes a straight line, and a surface obtained by extending the obtained straight line in the longitudinal direction of the electrophotographic photosensitive member (in the direction intersecting perpendicular to the circumferential direction) is defined as a reference surface. In the case where the electrophotographic photosensitive member is not cylindrical, the reference surface is obtained in the same manner as in the case where the electrophotographic photosensitive member is cylindrical.

A surface located 0.2 μm below from the obtained reference surface and parallel to the reference surface is defined as a second reference surface, and a surface located 0.2 μm above from the reference surface and parallel to the reference surface is defined as a third reference surface. In the 500 μm×500 μm square region, the portion interposed between the second reference surface and the third reference surface is defined as the flat part in the square region. The portion located above from the third reference surface is defined as the projected portion in the square region. The portion located below from the second reference surface is defined as the depressed portion in the square region. The distance from the second reference surface to the lowest point of the depressed portion is defined as the depth of the depressed portion. The cross section of the depressed portion taken along the second reference surface is defined as the opening of the depressed portion. Among line segments intersecting the opening, the length of the longest line segment is defined as the opening longest diameter of the depressed portion. Among the depressed portions, if the thus-determined depth is in the range of 0.5 to 5 μm and the thus-determined opening longest diameter is in the range of 20 μm to 80 μm, the depressed portions having such a depth and such an opening longest diameter correspond to the specific depressed portion. The depth of the specific depressed portion in the present invention can be in the range of 1 to 5 μm. The distance in which the distance between two parallel lines interposing the opening of depressed portion is defined as the opening shortest diameter of depressed portion. The opening shortest diameter of the specific depressed portion in the present invention is preferably the range of from 20 μm to 80 μm.

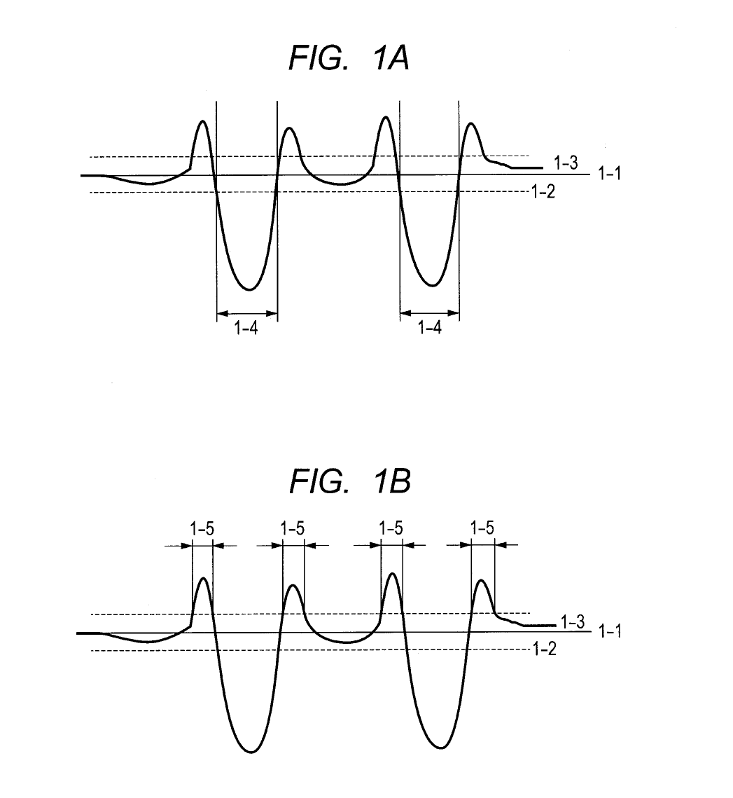

FIG. 1A and FIG. 1B schematically illustrate the relationship among the reference surface 1-1, the flat part (the portion interposed between the second reference surface 1-2 and the third reference surface 1-3), the depressed portion 1-4 (specific depressed portion), and the projected portion 1-5. FIG. 1A and FIG. 1B are the cross-sectional profile after the correction.

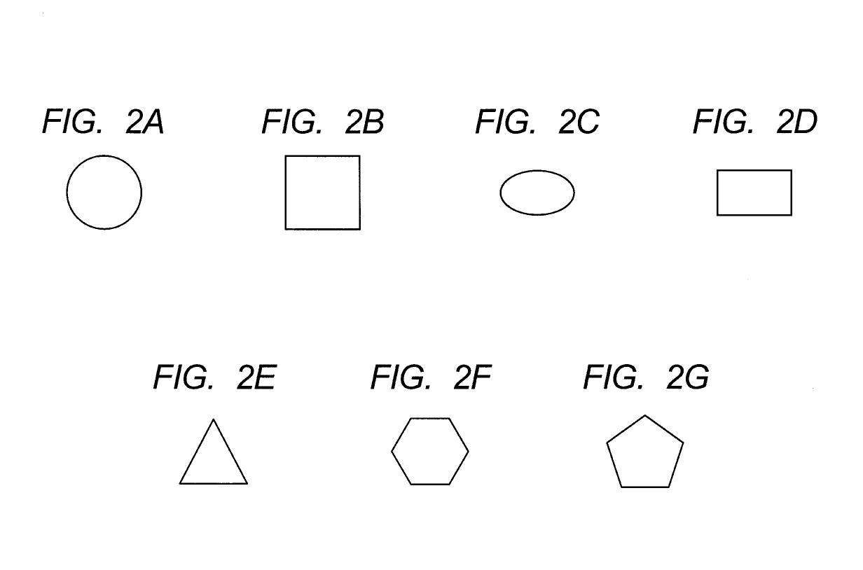

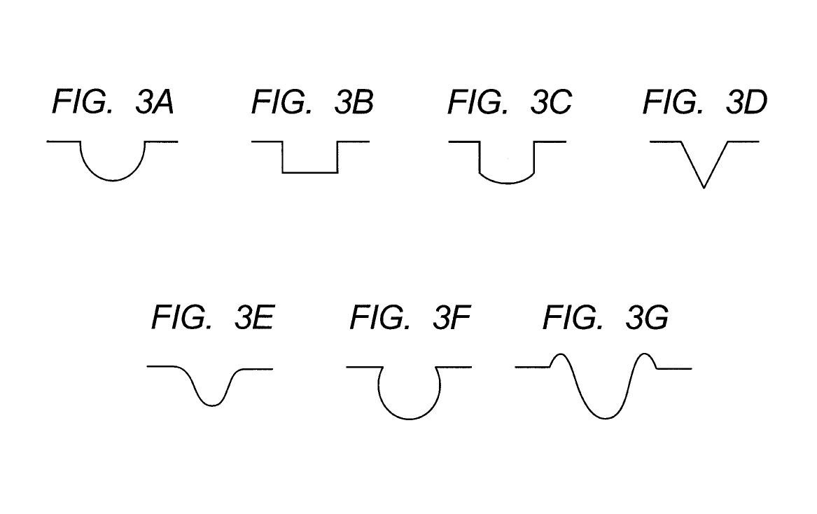

FIG. 2A to FIG. 2G illustrate an example of a shape of the opening of the specific depressed portion (shape when the specific depressed portion is observed from above). FIG. 3A to FIG. 3G illustrate an example of a shape of the cross section of the specific depressed portion.

Examples of the shape of the opening of the specific depressed portion include a circle, an ellipse, a square, a rectangle, a triangle, a quadrangle, and a hexagon as illustrated in FIG. 2A to FIG. 2G. Examples of the shape of the cross section of the specific depressed portion include shapes having edges such as a triangle, a quadrangle, a polygon, shapes formed with a continuous curve such as a wave form, and shapes having edges in a triangle, a quadrangle, and a polygon partially or totally transformed into a curve as illustrated in FIG. 3A to FIG. 3G.

The plurality of specific depressed portions provided on the surface of the electrophotographic photosensitive member all may have the same shape, opening longest diameter, and depth, or may have different shapes, opening longest diameters, and depths mixed.

The specific depressed portions may be provided all over the surface of the electrophotographic photosensitive member, or may be formed on part of the surface of the electrophotographic photosensitive member. In the case where the specific depressed portions are formed on part of the surface of the electrophotographic photosensitive member, the specific depressed portions can be provided at least all over the contact area with the cleaning member.

In the present invention, from the viewpoint of enhancing properties of removing the image deletion-causing substances, the flat part provided on the surface of the electrophotographic photosensitive member can have an area to some extent, and the area of a narrow flat part (narrow area) can be small. Specifically, of the flat part in the 500 μm×500 μm square region provided in an arbitrary position of the surface of the electrophotographic photosensitive member, the proportion of the area of the narrow area in which the 10 μm×10 μm square region cannot be disposed can be not more than 30% based on the total area of the flat part in the 500 μm×500 μm square region with.

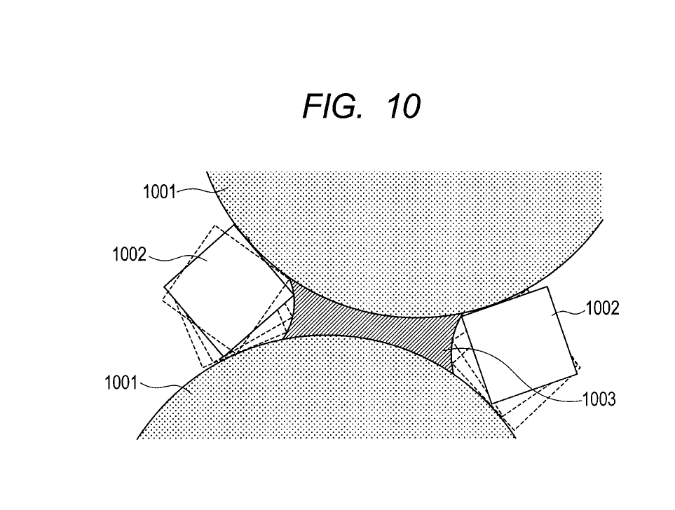

FIG. 10 is a drawing for describing the narrow area. FIG. 10 illustrates an example of a shape when part of the surface of the electrophotographic photosensitive member in the present invention is observed from above. In FIG. 10, for convenience of description, an example is illustrated in which all of the portions other than the specific depressed portion are the flat part. FIG. 10 illustrates a specific depressed portion 1001 of the surface of the electrophotographic photosensitive member, a 10 μm×10 μm square region 1002 disposed in the flat part of the surface of the electrophotographic photosensitive member, and a narrow area 1003 (the solid black portion in the drawing). The square region 1002 may be disposed in any direction in the flat part as illustrated by the squares written by the dashed line in the drawing. A portion in which the square region 1002 can not be disposed in the flat part in any direction is the narrow area 1003 in the flat part.

From the viewpoint of making the properties of removing the image deletion-causing substances uniform, the proportion of the area of the narrow area in the flat part can be uniform to some extent in the surface of the electrophotographic photosensitive member. Specifically, when the proportion of the area of the narrow area is measured in the 500 μm×500 μm square regions disposed in an arbitrary 50 positions of the surface of the electrophotographic photosensitive member, the standard deviation of the 50 measured values (standard deviation of the narrow area) can be not more than 5%.

Method for Forming Depressed Portions on Surface of Electrophotographic Photosensitive Member>

A mold having projected portions corresponding to the depressed portions to be formed is pressure contacted with the surface of the electrophotographic photosensitive member to transfer the shape. Thereby, the depressed portions can be formed on the surface of the electrophotographic photosensitive member.

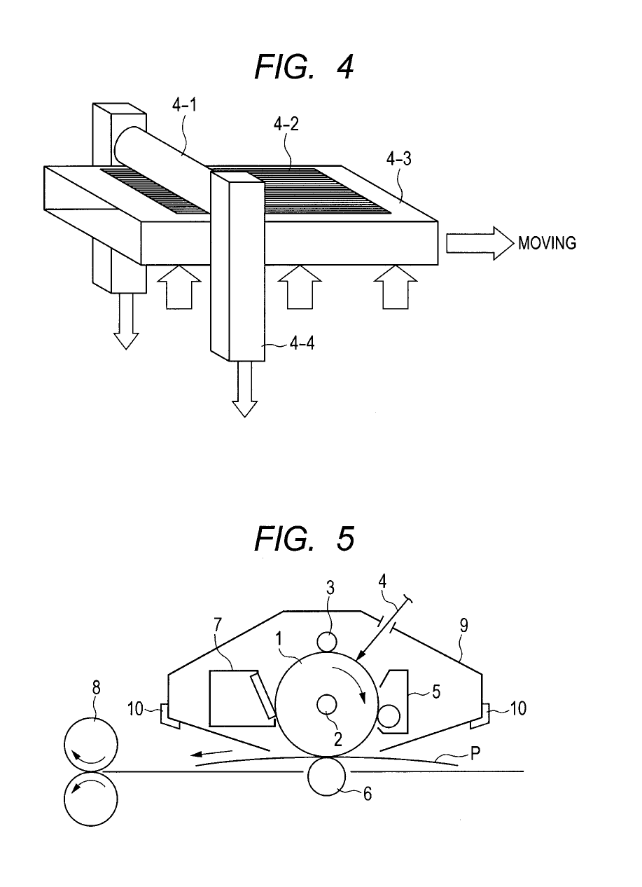

FIG. 4 illustrates an example of an abut pressure shape transfer machine for forming the depressed portions on the surface of the electrophotographic photosensitive member.

According to the abut pressure shape transfer machine illustrated in FIG. 4, while an electrophotographic photosensitive member 4-1 to be processed is rotated, a mold 4-2 is continuously contacted with the surface (circumferential surface) of the electrophotographic photosensitive member, and pressure is applied. Thereby, the depressed portions and the flat part can be formed on the surface of the electrophotographic photosensitive member 4-1.

Examples of the material for a pressurizing member 4-3 include metals, metal oxides, plastics, and glass. Among these, preferable is stainless steel (SUS) from the viewpoint of mechanical strength, precision in size, and durability. The mold is provided on the top surface of the pressurizing member 4-3. By a supporting member (not illustrated) and a pressurizing system (not illustrated) on the bottom surface side of the pressurizing member 4-3, the mold 4-2 can be contacted with the surface of the electrophotographic photosensitive member 4-1 supported by a supporting member 4-4 at a predetermined pressure. The supporting member 4-4 may also be pressed against the pressurizing member 4-3 at a predetermined pressure, or the supporting member 4-4 and the pressurizing member 4-3 may be pressed against each other.

The example illustrated in FIG. 4 is an example in which the pressurizing member 4-3 is moved to continuously process the surface of the electrophotographic photosensitive member 4-1 while the electrophotographic photosensitive member 4-1 follows or is driven to rotate. Further, the pressurizing member 4-3 is fixed and the supporting member 4-4 is moved, or both of the supporting member 4-4 and the pressurizing member 4-3 are moved. Thereby, the surface of the electrophotographic photosensitive member 4-1 can be continuously processed.

From the viewpoint of efficient shape transfer, the mold 4-2 and the electrophotographic photosensitive member 4-1 can be heated.

Examples of the mold include those made of finely surface-processed metals and resin films, those made of a silicon wafer or the like having a surface patterned by a resist, and those made of resin films having fine particles dispersed and resin films having a fine surface shape and coated with a metal.

From the viewpoint of a uniform pressure applied to the electrophotographic photosensitive member, an elastic body can be provided between the mold and the pressurizing member.

Configuration of Electrophotographic Photosensitive Member>

The electrophotographic photosensitive member according to the present invention has a support and a photosensitive layer formed on the support.

Examples of shapes of the electrophotographic photosensitive member include a cylindrical shape, a belt (endless belt)-like shape, and a sheet-like shape.

The photosensitive layer may be a single photosensitive layer containing a charge transport substance and a charge-generating substance in the same layer, or may be a laminated (function-separating type) photosensitive layer in which a charge-generating layer containing a charge-generating substance is separated from a charge-transport layer containing a charge transport substance. From the viewpoint of electrophotographic properties, the laminated photosensitive layer is preferable. Moreover, the laminated photosensitive layer may be a normal laminate photosensitive layer in which the charge-generating layer and the charge-transport layer are laminated in this order from the support side, or a reverse laminate photosensitive layer in which the charge-transport layer and the charge-generating layer are laminated in this order from the support side. From the viewpoint of the electrophotographic properties, the normal laminate photosensitive layer is preferable. The charge-generating layer may also have a laminated layer configuration, or the charge-transport layer may have a laminated layer configuration.

The support can be a support showing conductivity (conductive support). Examples of a material for the support include metals (alloys) such as iron, copper, gold, silver, aluminum, zinc, titanium, lead, nickel, tin, antimony, indium, chromium, aluminum alloys, and stainless steel. Metallic supports and plastic supports having a coating film formed by vacuum evaporation using aluminum, an aluminum alloy, and an indium oxide-tin oxide alloy can also be used. Supports obtained by impregnating a conductive particle such as carbon black, tin oxide particles, titanium oxide particles, and silver particles into a plastic or paper, and supports made of conductive binder resins can also be used.

The surface of the support may be subjected to machining, surface roughening, and alumite treatment in order to suppress interference fringes caused by scattering of laser light.

Between the support and a subbing layer described later or the photosensitive layer (charge-generating layer, charge-transport layer), a conductive layer may be provided in order to suppress interference fringes caused by scattering of laser light and coat scratches of the support.

The conductive layer can be formed as follows: carbon black, a conductive pigment, and a resistance controlling pigment are dispersed with a binder resin to obtain a coating solution for a conductive layer, the obtained coating solution is applied, and the obtained coating film is dried. Moreover, a compound curable and polymerizable by heating, irradiation with ultraviolet rays, and irradiation with radiation may be added to the coating solution for a conductive layer. The surface of the conductive layer formed by dispersing a conductive pigment and a resistance controlling pigment is likely to be roughened.

The film thickness of the conductive layer is preferably from 0.2 to 40 μm, and more preferably from 1 to 35 μm, and more preferably from 5 to 30 μm.

Examples of the binder resin used for the conductive layer include polymers of vinyl compounds such as styrene, vinyl acetate, vinyl chloride, acrylic acid esters, methacrylic acid ester, vinylidene fluoride, and trifluoroethylene, polyvinyl alcohols, polyvinyl acetals, polycarbonates, polyesters, polysulfones, polyphenylene oxide, polyurethanes, cellulose resins, phenol resins, melamine resins, silicon resins, and epoxy resins.

Examples of the conductive pigment and the resistance controlling pigment include particles of metals (alloy) such as aluminum, zinc, copper, chromium, nickel, silver, and stainless steel, and plastic particles having a surface coated with these metallic particles. Moreover, particles of metal oxides such as zinc oxide, titanium oxide, tin oxide, antimony oxide, indium oxide, bismuth oxide, tin-doped indium oxide, and antimony-doped or tantalum-doped tin oxide can be used. One of these can be used alone, or two or more thereof can be used in combination. In the case where two or more thereof is used in combination, those may be only mixed, or may be used as a solid solution or fused.

Between the support or conductive layer and the photosensitive layer (charge-generating layer, charge-transport layer), a subbing layer (intermediate layer) having a barrier function or an adhesive function may be provided in order to improve adhesiveness of the photosensitive layer, applicability, and charge injecting properties from the support, and protect the photosensitive layer from electrical damage.

The subbing layer can be formed as follows: a resin (binder resin) is dissolved in a solvent to obtain a coating solution for a subbing layer, the obtained coating solution is applied, and the obtained coating film is dried.

Examples of the resin used for the subbing layer include polyvinyl alcohol, poly-N-vinylimidazole, polyethylene oxide, ethyl cellulose, ethylene-acrylic acid copolymers, caseins, polyamides, N-methoxymethylated 6 nylon, copolymerized nylons, glue, and gelatin.

The film thickness of the subbing layer is preferably from 0.05 to 7 μm, and more preferably from 0.1 to 2 μm.

Examples of the charge-generating substance used for the photosensitive layer include pyrylium and thiapyrylium dyes, phthalocyanine pigments having a variety of central metals and a variety of crystal forms (α, β, γ, ε, X type, and the like), anthanthrone pigments, dibenzpyrenequinone pigments, pyranthrone pigments, azo pigments such as monoazo, disazo, and trisazo, indigo pigments, quinacridone pigments, asymmetric quinocyanine pigments, and quinocyanine pigments. One of these charge-generating substances may be used alone, or two or more thereof may be used.

Examples of the charge transport substance used for the photosensitive layer include pyrene compounds, N-alkylcarbazole compounds, hydrazone compounds, N,N-dialkylaniline compounds, diphenylamine compounds, triphenylamine compounds, triphenylmethane compounds, pyrazoline compounds, styryl compounds, and stilbene compounds.

In the case where the photosensitive layer is a laminated photosensitive layer, the charge-generating layer can be formed as follows: the charge-generating substance is dispersed with the binder resin and a solvent, the obtained coating solution for a charge-generating layer is applied, and the obtained coating film is dried. The charge-generating layer may also be a deposited film of the charge-generating substance.

The ratio of the mass of the charge-generating substance to that of the binder resin can be in the range of from 1:0.3 to 1:4.

Examples of the dispersion method include methods using a homogenizer, ultrasonic dispersion, a ball mill, a vibration ball mill, a sand mill, an Attritor, and a roll mill.

The charge-transport layer can be formed as follows: the charge transport substance and the binder resin are dissolved in a solvent to obtain a coating solution for a charge-transport layer, the obtained coating solution is applied, and the obtained coating film is dried. In the case where the charge transport substance having film forming properties by itself is used, the charge-transport layer can also be formed without using the binder resin.

Examples of the binder resin used for the charge-generating layer and the charge-transport layer include polymers of vinyl compounds such as styrene, vinyl acetate, vinyl chloride, acrylic acid ester, methacrylic acid ester, vinylidene fluoride, and trifluoroethylene, polyvinyl alcohols, polyvinyl acetals, polycarbonates, polyesters, polysulfones, polyphenylene oxide, polyurethanes, cellulose resins, phenol resins, melamine resins, silicon resins, and epoxy resins.

The film thickness of the charge-generating layer is preferably not more than 5 μm, and more preferably from 0.1 to 2 μm.

The film thickness of the charge-transport layer is preferably from 5 to 50 μm, and more preferably from 10 to 35 μm.

From the viewpoint of improving durability of the electrophotographic photosensitive member, the surface layer of the electrophotographic photosensitive member can be formed with a crosslinked organic polymer.

In the present invention, for example, the charge-transport layer on the charge-generating layer can be formed with a crosslinked organic polymer as the surface layer of the electrophotographic photosensitive member. Moreover, a surface layer formed with a crosslinked organic polymer can be formed on the charge-transport layer on the charge-generating layer as a second charge-transport layer or a protective layer. The surface layer formed with a crosslinked organic polymer needs to have compatibility of film strength with the charge transport ability. From such a viewpoint, the surface layer can be formed using a charge transport substance or a conductive particle and a crosslinked polymerizable monomer/oligomer.

As the charge transport substance, the charge transport substance described above can be used. Examples of the crosslinked polymerizable monomer/oligomer include compounds having a chain polymerizable functional group such as an acryloyloxy group and a styryl group, and compounds having a sequentially polymerizable functional group such as a hydroxy group, an alkoxysilyl group, and an isocyanate group.

From the viewpoint of the compatibility of the film strength with the charge transport ability, use of a compound having a charge transportable structure (preferably, a hole-transportable structure) and an acryloyloxy group in the same molecule is more preferable.

Examples of the method for crosslinking and curing the crosslinked polymerizable monomer/oligomer include methods using heat, ultraviolet rays, and radiation.

The film thickness of the surface layer formed with the crosslinked organic polymer is preferably from 0.1 to 30 μm, and more preferably from 1 to 10 μm.

Additives can be added to the respective layers in the electrophotographic photosensitive member. Examples of the additives include deterioration preventing agents such as an antioxidant and an ultraviolet absorbing agent, organic resin particles such as fluorine atom containing resin particles and acrylic resin particles, and inorganic particles such as silica, titanium oxide, and alumina.

Configuration of Process Cartridge and that of Electrophotographic Apparatus>

FIG. 5 illustrates an example of an electrophotographic apparatus including a process cartridge having the electrophotographic photosensitive member according to the present invention.

In FIG. 5, a cylindrical electrophotographic photosensitive member 1 according to the present invention is rotated and driven around a shaft 2 in the arrow direction at a predetermined circumferential speed (process speed). The surface of the electrophotographic photosensitive member 1 is uniformly charged at a predetermined positive or negative potential by a charging unit 3 (a primary charging unit: for example, a charging roller) during rotation. Next, the surface of the electrophotographic photosensitive member 1 receives exposure light (image exposure light) 4 irradiated from an exposure unit (image exposure unit) (not illustrated). Thus, an electrostatic latent image corresponding to the target image information is formed on the surface of the electrophotographic photosensitive member 1.

In the present invention, the effect is particularly remarkable in the case where a charging unit using discharging is used.

Next, the electrostatic latent image formed on the surface of the electrophotographic photosensitive member 1 is developed (normally developed or reversely developed) by a toner in a developing unit 5 (an amorphous toner or a spherical toner) to form a toner image. The toner image formed on the surface of the electrophotographic photosensitive member 1 is transferred onto a transfer material by a transfer bias from a transfer unit (for example, a transfer roller) 6. At this time, the transfer material P is taken from a transfer material feeding unit (not illustrated) and fed between the electrophotographic photosensitive member 1 and the transfer unit 6 (abut region) in synchronization with rotation of the electrophotographic photosensitive member 1. A bias voltage having polarity opposite to that of the charged toner is applied to the transfer unit from a bias power supply (not illustrated).

The transfer material P having the toner image transferred is separated from the surface of the electrophotographic photosensitive member, and conveyed to a fixing unit 8 to fix the toner image. Thereby, the transfer material P is printed out as an image forming product (print, copy) to the outside of the electrophotographic apparatus.

After transfer of the toner image, the surface of the electrophotographic photosensitive member 1 is cleaned by removing adhering products such as a transfer remaining toner by a cleaning unit 7 having a cleaning member (such as a cleaning blade) disposed in contact with (abutting) the surface of the electrophotographic photosensitive member 1. Further, the surface of the electrophotographic photosensitive member 1 is neutralized by pre-exposure light (not illustrated) from a pre-exposure unit (not illustrated), and repeatedly used for image formation. As illustrated in FIG. 5, in the case where the charging unit 3 is a contact charging unit using a charging roller or the like, the pre-exposure is not always needed.

In the present invention, among components selected from the electrophotographic photosensitive member 1, the charging unit 3, the developing unit 5, and the cleaning unit 7, a plurality of components may be accommodated in a container and integrally formed as a process cartridge. Moreover, the process cartridge may be detachably attached to the main body of the electrophotographic apparatus such as a copier and a laser beam printer. In FIG. 5, the electrophotographic photosensitive member 1, the charging unit 3, the developing unit 5, and the cleaning unit 7 are integrally supported to form a cartridge. Using a guide unit 10 such as a rail in the main body of the electrophotographic apparatus, the process cartridge 9 is detachably attachable to the main body of the electrophotographic apparatus.

In the case where the electrophotographic apparatus is a copier or a printer, the exposure light 4 is the light irradiated by scanning with a laser beam or driving of an LED array or a liquid crystal shutter array, which is performed according to a signal obtained by reading reflected light or transmitted light from an original or reading an original by a sensor.

### EXAMPLE

Hereinafter, using specific Examples, the present invention will be described more in detail. In Examples, “parts” means “parts by mass.” The electrophotographic photosensitive member is simply referred to as a “photosensitive member” below. In all following examples, the shape of the opening of depressed portions formed on the surface of an electrophotographic photosensitive member is circular shape in which the opening longest diameter is equivalent to the opening shortest diameter.

(Production Example of Photosensitive Member A-1)

An aluminum cylinder having a diameter of 30.7 mm and a length of 370 mm was used as the support (cylindrical support).

Next, 60 parts of barium sulfate particles coated with tin oxide (trade name: Passtran PC1, made by Mitsui Mining & Smelting Co., Ltd.), 15 parts of titanium oxide particles (trade name: TITANIX JR, made by Tayca Corporation), 43 parts of a phenolic resole resin (trade name: PHENOLITE J-325, made by DIC Corporation, solid content of 70% by mass), 0.015 parts of silicone oil (trade name: SH28PA, made by Dow Corning Toray Co., Ltd.), 3.6 parts of silicone resin particles (trade name: Tospearl 120, made by Momentive Performance Materials Inc.), 50 parts of 2-methoxy-1-propanol, and 50 parts of methanol were placed in a ball mill, and dispersed for 20 hours to prepare a coating solution for a conductive layer. The coating solution for a conductive layer was applied onto the support by dip coating. The obtained coating film was heated for 1 hour at 140° C. to be cured. Thereby, a conductive layer having a film thickness of 15 μm was formed.

Next, 10 parts of a copolymerized nylon (trade name: made by AMILAN CM8000, Toray Industries, Inc.) and 30 parts of a methoxymethylated 6 nylon resin (trade name: TORESIN EF-30T, made by Nagase ChemteX Corporation) were dissolved in a mixed solvent of 400 parts of methanol/200 parts of n-butanol to prepare a coating solution for a subbing layer. The coating solution for a subbing layer was applied onto the conductive layer by dip coating. The obtained coating film was dried for 30 minutes at 100° C. to form a subbing layer having a film thickness of 0.45 μm.

Next, 20 parts of hydroxy gallium phthalocyanine crystals having strong peaks at Bragg angles of 2θ±0.2° of 7.4° and 28.2° in CuKα characteristics X ray diffraction (charge-generating substance), 0.2 parts of a calixarene compound represented by the following structural formula (1):

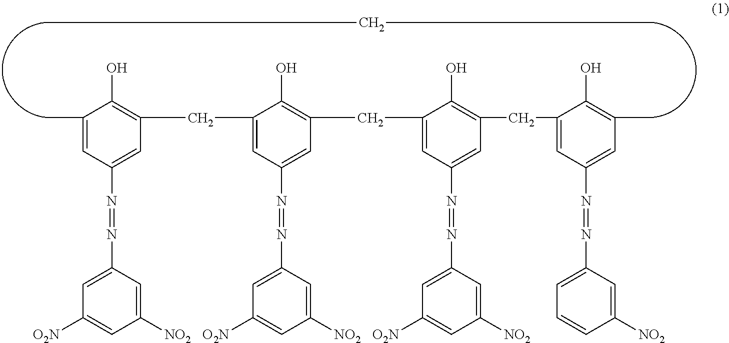

10 parts of polyvinyl butyral (trade name: S-LEC BX-1, made by Sekisui Chemical Co., Ltd.), and 600 parts of cyclohexanone were placed in a sand mill using glass beads having a diameter of 1 mm, and dispersed for 4 hours. Then, 700 parts of ethyl acetate was added to prepare a coating solution for a charge-generating layer. The coating solution for a charge-generating layer was applied onto the subbing layer by dip coating. The obtained coating film was dried for 15 minutes at 80° C. to form a charge-generating layer having a film thickness of 0.17 μm.

Next, 70 parts of a compound (charge transport substance (hole transportable compound)) represented by the following structural formula (2):

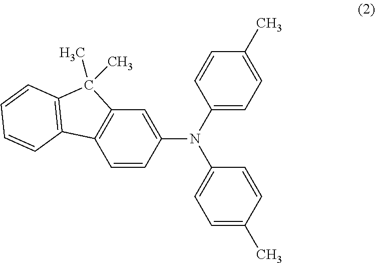 [SMILES: Cc1ccc(N(c2ccc(C)cc2)c2ccc3c(c2)C(C)(C)c2ccccc2-3)cc1]

and 100 parts of polycarbonate (trade name: Iupilon Z400, made by Mitsubishi Engineering-Plastics Corporation, bisphenol Z type polycarbonate) were dissolved in a mixed solvent of 600 parts of monochlorobenzene/200 parts of dimethoxymethane to prepare a coating solution for a charge-transport layer. The coating solution for a charge-transport layer was applied onto the charge-generating layer by dip coating. The obtained coating film was dried for 30 minutes at 100° C. to form a charge-transport layer having a film thickness of 15 μm.

Next, a mixed solvent of 20 parts of 1,1,2,2,3,3,4-heptafluorocyclopentane (trade name: ZEORORA H, made by ZEON Corporation)/20 parts of 1-propanol was filtered by a polyflon filter (trade name: PF-040, made by Advantec Toyo Kaisha, Ltd.). Subsequently, 90 parts of a hole transportable compound represented by the following structural formula (3):

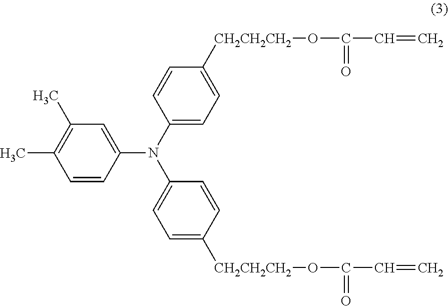

70 parts of 1,1,2,2,3,3,4-heptafluorocyclopentane, and 70 parts of 1-propanol were added to the mixed solvent. The mixed solution was filtered by a polyflon filter (trade name: PF-020, made by Advantec Toyo Kaisha, Ltd.) to prepare a coating solution for a second charge-transport layer (protective layer). The coating solution for a second charge-transport layer was applied onto the charge-transport layer by dip coating. The obtained coating film wad dried in the air for 10 minutes at 50° C. Subsequently, in nitrogen, the coating film was irradiated with an electron beam for 1.6 seconds on the condition of an accelerating voltage of 150 kV and a beam current of 3.0 mA while the support (to be irradiated) was rotated at 200 rpm. The absorbed dose of the electron beam at this time was measured, and it was 15 kGy. Subsequently, in nitrogen, the coating film was heated by raising the temperature from 25° C. to 125° C. over 30 seconds. The concentration of oxygen in the atmosphere during irradiation with the electron beam and the subsequent heating was not more than 15 ppm. Next, the coating film was naturally cooled in the air to 25° C., and heated in the air for 30 minutes at 100° C. Thereby, a second charge-transport layer (protective layer) having a film thickness of 5 μm was formed.

Thus, the cylindrical electrophotographic photosensitive member before depressed portions had been formed on the surface thereof (electrophotographic photosensitive member before formation of the depressed portion) was produced.

Formation of Depressed Portions by Mold Abut Pressure Shape Transfer

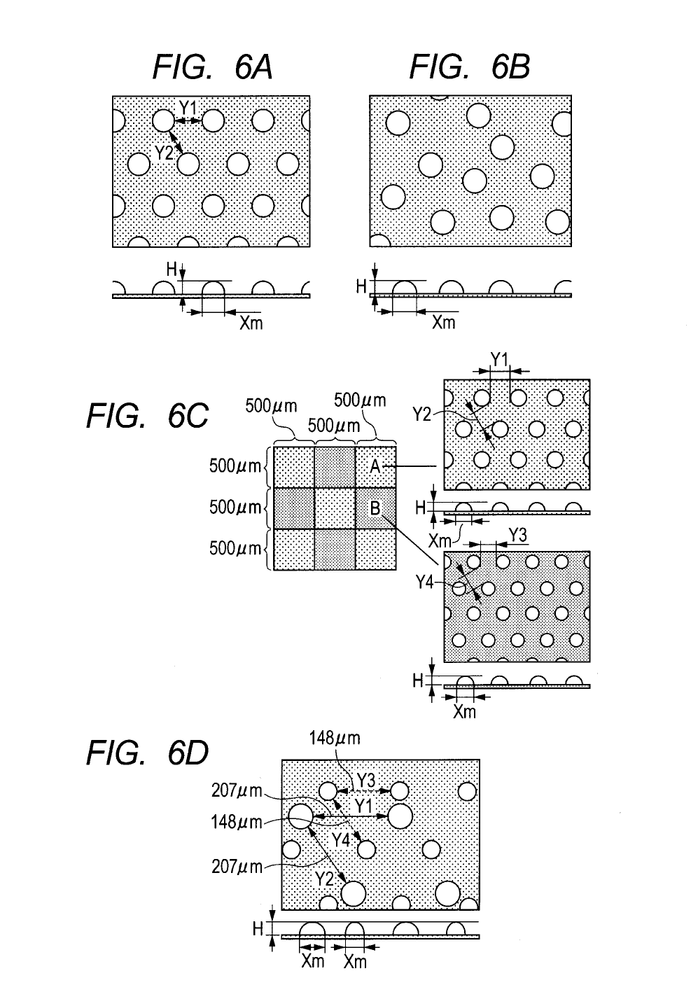

In an abut pressure shape transfer machine having the configuration generally illustrated in FIG. 4, as a mold, a mold having the shape generally illustrated in FIG. 6A (in the present example, a dome shape having the longest diameter (i.e., the longest diameter when the projected portion on the mold is observed from above; the same is true below) Xm: 50 μm, a distance (an interval) Y1: 64 μm, a distance (an interval) Y2: 77 μm, a height H, 2.0 μm) was provided. The produced electrophotographic photosensitive member before formation of the depressed portions was surface processed. During the processing, the temperatures of the electrophotographic photosensitive member and the mold were controlled such that the temperature of the surface of the electrophotographic photosensitive member was 110° C., and while the electrophotographic photosensitive member was pressed against the pressurizing member at a pressure of 3.0 MPa, the electrophotographic photosensitive member was rotated in the circumferential direction to form the depressed portions all over the surface (circumferential surface) of the electrophotographic photosensitive member.

Thus, an electrophotographic photosensitive member having the depressed portions on the surface thereof was produced. The electrophotographic photosensitive member is referred to as “Photosensitive member A-1.”

Observation of Surface of Electrophotographic Photosensitive Member

The surface of the obtained electrophotographic photosensitive member (Photosensitive member A-1) was magnified and observed by a laser microscope (made by Keyence Corporation, trade name: VK-9500) using a 50× lens, and the specific depressed portions and flat part provided on the surface of the electrophotographic photosensitive member were evaluated as described above. During observation, adjustment was made such that the longitudinal direction of the electrophotographic photosensitive member was not inclined, and vertices of the arc of the electrophotographic photosensitive member were focused in the circumferential direction. The 500 μm×500 μm square region was obtained by combining the magnified and observed images into one by an image combining application. Moreover, in the obtained results, using an attached image analyzing software, image processing height data was selected, and filtered by a filter type median.

From the observation, the depth, opening longest diameter, and area of the specific depressed portion, the area of the flat part, and the proportion of the area of the narrow area in the flat part and the standard deviation were determined. The results are shown in Table 1.

The surface of the electrophotographic photosensitive member (Photosensitive member A-1) was observed using other laser microscope (made by Keyence Corporation, trade name: X-200) by the same manner. The same results as that obtained using the laser microscope (made by Keyence Corporation, trade name: VK-9500) were obtained. In the examples below, the surface of the electrophotographic photosensitive member (Photosensitive member) was observed using a laser microscope (made by Keyence Corporation, trade name: VK-9500) and a 50× lens.

(Production Examples of Photosensitive Members A-2 to A-4)

Each electrophotographic photosensitive member was produced in the same manner as in Production Example of Photosensitive member A-1 except that the mold used in Production Example of Photosensitive member A-1 was replaced by the mold shown in Table 1. The obtained electrophotographic photosensitive members having the depressed portions on the surface thereof are referred to as “Photosensitive member A-2” to “Photosensitive member A-4.”

The surface of each electrophotographic photosensitive member obtained was observed in the same manner as in Production Example of Photosensitive member A-1. The results are shown in Table 1.

(Production Example of Photosensitive Member A-5)

An electrophotographic photosensitive member was produced in the same manner as in Production Example of Photosensitive member A-1 except that instead of the aluminum cylinder and mold used in Production Example of Photosensitive member A-1, an aluminum cylinder having a diameter of 84 mm and a length of 370 mm was used as the support (cylindrical support), and the mold shown in Table 1 was used as the mold. The obtained electrophotographic photosensitive member having the depressed portions on the surface thereof is referred to as “Photosensitive member A-5.”

The surface of the obtained electrophotographic photosensitive member was observed in the same manner as in Production Example of Photosensitive member A-1. The results are shown in Table 1.

(Production Examples of Photosensitive Members A-6 to A-22)

Each electrophotographic photosensitive member was produced in the same manner as in Production Example of Photosensitive member A-1 except that the mold used in Production Example of Photosensitive member A-1 was replaced by the mold shown in Table 1. The obtained electrophotographic photosensitive members having the depressed portions on the surface thereof are referred to as “Photosensitive member A-6” to “Photosensitive member A-22.”

The surface of each electrophotographic photosensitive member obtained was observed in the same manner as in Production Example of Photosensitive member A-1. The results are shown in Table 1.

(Production Example of Photosensitive Member A-23)

A conductive layer, a subbing layer, a charge-generating layer, and a charge-transport layer were formed on the support in the same manner as in Production Example of Photosensitive member A-1.

Next, a mixed solution obtained by mixing 10 parts of alumina particles (average particle diameter: 0.1 μm, trade name: LS-231, made by Nippon Light Metal Company, Ltd.) with 90 parts of chlorobenzene was placed in a high pressure disperser (trade name: Microfluidizer M-110EH, made by Microfluidics Corporation), and dispersed at a pressure of 600 kgf/cm² three times. Further, the dispersed mixed solution was filtered by a polyflon filter (trade name: PF-040, made by Advantec Toyo Kaisha, Ltd.) to prepare a dispersion liquid.

Next, 70 parts of a compound having the structure represented by the above structural formula (2), 100 parts of polycarbonate (trade name: Iupilon Z400, made by Mitsubishi Engineering-Plastics Corporation), 200 parts of the dispersion liquid, 400 parts of monochlorobenzene, and 200 parts of dimethoxymethane were mixed to prepare a coating solution for a second charge-transport layer (protective layer). The coating solution for a second charge-transport layer was sprayed onto the charge-transport layer, and the obtained coating film was dried for 20 minutes at 130° C. to form a second charge-transport layer (protective layer) having a film thickness of 5 μm.

Thus, an electrophotographic photosensitive member before formation of the depressed portions was produced.

Subsequently, the depressed portions were formed all over the surface (circumferential surface) of the electrophotographic photosensitive member before formation of the depressed portions in the same manner as in Production Example of Photosensitive member A-1 except that the mold shown in Table 1 was used as the mold. The thus-obtained electrophotographic photosensitive member having the depressed portions on the surface thereof is referred to as “Photosensitive member A-23.”

The surface of the obtained electrophotographic photosensitive member was observed in the same manner as in Production Example of Photosensitive member A-1. The results are shown in Table 1.

(Production Example of Photosensitive Member A-24)

An electrophotographic photosensitive member was produced in the same manner as in Production Example of Photosensitive member A-1 except that instead of the aluminum cylinder and mold used in Production Example of Photosensitive member A-1, an aluminum cylinder having a diameter of 24 mm and a length of 260.5 mm was used as the support (cylindrical support), and the mold shown in Table 1 was used as the mold. The obtained electrophotographic photosensitive member having the depressed portions on the surface thereof is referred to as “Photosensitive member A-24.”

The surface of the obtained electrophotographic photosensitive member was observed in the same manner as in Production Example of Photosensitive member A-1. The results are shown in Table 1.

(Production Example of Photosensitive Member A-25)

An electrophotographic photosensitive member was produced in the same manner as in Production Example of Photosensitive member A-1 except that the mold used in Production Example of Photosensitive member A-1 was replaced by the mold shown in Table 1. The obtained electrophotographic photosensitive member having the depressed portions on the surface thereof is referred to as “Photosensitive member A-25.”

The surface of the obtained electrophotographic photosensitive member was observed in the same manner as in Production Example of Photosensitive member A-1. The results are shown in Table 1.

(Production Example of Photosensitive Member A-26)

A conductive layer, a subbing layer, a charge-generating layer, and a charge-transport layer were formed on the support in the same manner as in Production Example of Photosensitive member A-1.

Next, using a mold shown in Table 1 as the mold, the depressed portions were formed on the surface of the charge-transport layer. Then, a second charge-transport layer (protective layer) having a film thickness of 2 μm was formed in the same manner as in Production Example of Photosensitive member A-1.

Thus, an electrophotographic photosensitive member having the depressed portions on the surface thereof was produced. The electrophotographic photosensitive member is referred to as “Photosensitive member A-26.”

The surface of the obtained electrophotographic photosensitive member was observed in the same manner as in Production Example of Photosensitive member A-1. The results are shown in Table 1.

(Production Example of Photosensitive Member A-27)

An electrophotographic photosensitive member was produced in the same manner as in Production Example of Photosensitive member A-1 except that instead of the aluminum cylinder and mold used in Production Example of Photosensitive member A-1, an aluminum cylinder having a diameter of 30 mm and a length of 260.5 mm was used as the support (cylindrical support), and the mold shown in Table 1 was used as the mold. The obtained electrophotographic photosensitive member having the depressed portions on the surface thereof is referred to as “Photosensitive member A-27.”

The surface of the obtained electrophotographic photosensitive member was observed in the same manner as in Production Example of Photosensitive member A-1. The results are shown in Table 1.

(Production Examples of Photosensitive Members A-28 to A-30)

Each electrophotographic photosensitive member was produced in the same manner as in Production Example of Photosensitive member A-1 except that instead of the mold used in Production Example of Photosensitive member A-1, the mold shown in Table 1 was used as the mold, and the temperatures of the electrophotographic photosensitive member and the mold were controlled such that the temperature of the surface of the electrophotographic photosensitive member was the temperature shown in Table 1 during the processing. The obtained electrophotographic photosensitive members having the depressed portions on the surface thereof are referred to as “Photosensitive member A-28” to “Photosensitive member A-30.”

The surface of each electrophotographic photosensitive member obtained was observed in the same manner as in Production Example of Photosensitive member A-1. The results are shown in Table 1.

(Production Example of Photosensitive Member A-31)

A conductive layer, a subbing layer, a charge-generating layer, and a charge-transport layer were formed on the support in the same manner as in Production Example of Photosensitive member A-1.

Next, using the mold shown in Table 1 as the mold, the depressed portions were formed on the surface of the charge-transport layer. Then, a second charge-transport layer (protective layer) having a film thickness of 2 μm was formed in the same manner as in Production Example of Photosensitive member A-1.

Thus, an electrophotographic photosensitive member having the depressed portions on the surface thereof was produced. The electrophotographic photosensitive member is referred to as “Photosensitive member A-31.”

The surface of the obtained electrophotographic photosensitive member was observed in the same manner as in Production Example of Photosensitive member A-1. The results are shown in Table 1.

(Production Example of Photosensitive Member A-32)

A conductive layer, a subbing layer, a charge-generating layer, and a charge-transport layer were formed on the support in the same manner as in Production Example of Photosensitive member A-1.

Next, 0.5 parts of a fluorine atom containing resin (trade name: GF-300, made by TOAGOSEI CO., LTD.) as a dispersant was dissolved in a mixed solvent of 30 parts of 1,1,2,2,3,3,4-heptafluorocyclopentane (trade name: ZEORORA H, made by ZEON Corporation)/30 parts of 1-propanol, and 10 parts of polytetrafluoroethylene (trade name: Lubron L-2, made by DAIKIN INDUSTRIES, LTD.) as a lubricant was added. The mixed solution was placed in a high pressure disperser (trade name: Microfluidizer M-110EH, made by Microfluidics Corporation), and was dispersed at a pressure of 600 kgf/cm² four times. The obtained dispersion liquid was filtered by a polyflon filter (trade name: PF-040, made by Advantec Toyo Kaisha, Ltd.) to obtain a lubricant dispersion liquid. Subsequently, 90 parts of a hole transportable compound represented by the above structural formula (3), 70 parts of 1,1,2,2,3,3,4-heptafluorocyclopentane, and 70 parts of 1-propanol were added to the lubricant dispersion liquid. The lubricant dispersion liquid was filtered by a polyflon filter (trade name: PF-020, made by Advantec Toyo Kaisha, Ltd.) to prepare a coating solution for a second charge-transport layer (protective layer). The coating solution for a second charge-transport layer was applied onto the charge-transport layer by dip coating, and the obtained coating film was dried in the air for 10 minutes at 50° C. Subsequently, in nitrogen, the coating film was irradiated with an electron beam for 1.6 seconds on the condition of an accelerating voltage of 150 kV and a beam current of 3.0 mA while the support was rotated at 200 rpm. The absorbed dose of the electron beam at this time was measured, and it was 15 kGy. Subsequently, in nitrogen, the coating film was heated by raising the temperature from 25° C. to 125° C. over 30 seconds. The concentration of oxygen in the atmosphere during irradiation with the electron beam and the subsequent heating and curing was not more than 15 ppm. Next, the coating film was naturally cooled in the air to 25° C., and heated in the air for 30 minutes at 100° C. Thereby, a second charge-transport layer (protective layer) having a film thickness of 5 μm was formed.

Thus, an electrophotographic photosensitive member before formation of the depressed portions was produced.

Subsequently, the depressed portions were formed all over the surface of the electrophotographic photosensitive member before formation of the depressed portions in the same manner as in Production Example of Photosensitive member A-1 except that the mold shown in Table 1 was used as the mold. The thus-obtained electrophotographic photosensitive member having the depressed portions on the surface thereof is referred to as “Photosensitive member A-32.”

The surface of the obtained electrophotographic photosensitive member was observed in the same manner as in Production Example of Photosensitive member A-1. The results are shown in Table 1.

Moreover, the cross section in the vicinity of the second charge-transport layer that is the surface layer of Photosensitive member A-32 was observed. As illustrated in FIG. 8A, the depressed portions were formed such that the depressed portions corresponded not only to the surface of the second charge-transport layer but also to the surface of the charge-transport layer (an interface between the charge-transport layer and the second charge-transport layer). In Photosensitive members A-1 to A-31, Photosensitive members B-1 to B-10, Photosensitive members C-1 to C-3, Photosensitive member D-1, Photosensitive members E-1 to E-15, Photosensitive member E-17, and Photosensitive members E-18 to E-25 described later, the depressed portions were formed such that the depressed portions corresponded not only to the surface of the second charge-transport layer but also to the surface of the charge-transport layer. On the surface of Photosensitive member A-32, the depressed portions as illustrated in FIG. 8B were formed. A rectangle surrounded by a white line in FIG. 8B is a 500 μm×500 μm square region.

(Production Examples of Photosensitive Member A-33 to Photosensitive Member A-80)

Each electrophotographic photosensitive member was produced in the same manner as in Production Example of Photosensitive member A-1 except that instead of the mold used in Production Example of Photosensitive member A-1, the molds shown in Tables 1 to 3 were used as the mold, and the temperatures of the electrophotographic photosensitive member and the mold were controlled such that the temperature of the surface of the electrophotographic photosensitive member was the temperature shown in Tables 1 to 3 during the processing. The obtained electrophotographic photosensitive members having the depressed portions on the surface thereof are referred to as “Photosensitive member A-33” to “Photosensitive member A-80.”

The surface of each electrophotographic photosensitive member obtained was observed in the same manner as in Production Example of Photosensitive member A-1. The results are shown in Tables 1 to 3.

(Production Example of Photosensitive Member B-1)

An electrophotographic photosensitive member was produced in the same manner as in Production Example of Photosensitive member A-1 except that instead of the aluminum cylinder and mold used in Production Example of Photosensitive member A-1, an aluminum cylinder having a diameter of 84 mm and a length of 370 mm was used as the support (cylindrical support), and a mold having projected portions each having a shape generally illustrated in FIG. 6B disposed at random (by an error diffusion method (Floyd & Steinberg method)) (the detail is shown in Table 4) was used as the mold. The obtained electrophotographic photosensitive member having the depressed portions on the surface thereof is referred to as “Photosensitive member B-1.”

The surface of the obtained electrophotographic photosensitive member was observed in the same manner as in Production Example of Photosensitive member A-1. The results are shown in Table 4.

(Production Examples of Photosensitive Members B-2 to B-6)

Each electrophotographic photosensitive member was produced in the same manner as in Production Example of Photosensitive member A-1 except that instead of the mold used in Production Example of Photosensitive member A-1, a mold having projected portions each having a shape generally illustrated in FIG. 6B disposed at random (by the error diffusion method (Floyd & Steinberg method)) (the detail is shown in Table 4) was used as the mold. The obtained electrophotographic photosensitive members having the depressed portions on the surface thereof are referred to as “Photosensitive member B-2” to “Photosensitive member B-6.”

The surface of each electrophotographic photosensitive member obtained was observed in the same manner as in Production Example of Photosensitive member A-1. The results are shown in Table 4.

(Production Example of Photosensitive Member B-7)

An electrophotographic photosensitive member was produced in the same manner as in Production Example of Photosensitive member A-24 except that instead of the mold used in Production Example of Photosensitive member A-24, a mold having projected portions each having a shape generally illustrated in FIG. 6B disposed at random (by the error diffusion method (Floyd & Steinberg method)) (the detail is shown in Table 4) was used as the mold. The obtained electrophotographic photosensitive member having the depressed portions on the surface thereof is referred to as “Photosensitive member B-7.”

The surface of the obtained electrophotographic photosensitive member was observed in the same manner as in Production Example of Photosensitive member A-1. The results are shown in Table 4.

(Production Example of Photosensitive Member B-8)

An electrophotographic photosensitive member was produced in the same manner as in Production Example of Photosensitive member A-1 except that instead of the mold used in Production Example of Photosensitive member A-1, a mold having projected portions each having a shape generally illustrated in FIG. 6B disposed at random (by the error diffusion method (Floyd & Steinberg method)) (the detail is shown in Table 4) was used as the mold. The obtained electrophotographic photosensitive member having the depressed portions on the surface thereof is referred to as “Photosensitive member B-8.”

The surface of the obtained electrophotographic photosensitive member was observed in the same manner as in Production Example of Photosensitive member A-1. The results are shown in Table 4.

(Production Examples of Photosensitive Members B-9 and Photosensitive Member B-10)

Each electrophotographic photosensitive member was produced in the same manner as in Production Example of Photosensitive member A-1 except that instead of the mold used in Production Example of Photosensitive member A-1, a mold having projected portions each having a shape generally illustrated in FIG. 6B disposed at random (by the error diffusion method (Floyd & Steinberg method)) (the detail is shown in Table 4) was used as the mold. The obtained electrophotographic photosensitive members having the depressed portions on the surface thereof are referred to as “Photosensitive member B-9” and “Photosensitive member B-10.”

The surface of each electrophotographic photosensitive member obtained was observed in the same manner as in Production Example of Photosensitive member A-1. The results are shown in Table 4.

(Production Examples of Photosensitive Members C-1 to C-3)

Each electrophotographic photosensitive member was produced in the same manner as in Production Example of Photosensitive member A-1 except that instead of the mold used in Production Example of Photosensitive member A-1, a mold having regions A and B at a pitch of 500 μm in which the projected portions each having the shape generally illustrated in FIG. 6C were disposed differently (a projected portion in the A region: the longest diameter Xm, a distance (an interval) Y1, a distance (an interval) Y2, and a projected portion in the B region: the longest diameter Xm, a distance (an interval) Y3, a distance (an interval) Y4 were disposed respectively as shown in Table 5; the detail is shown in Table 5) was used. The obtained electrophotographic photosensitive members having the depressed portions on the surface thereof are referred to as “Photosensitive member C-1” to “Photosensitive member C-3.”

The surface of each electrophotographic photosensitive member obtained was observed in the same manner as in Production Example of Photosensitive member A-1. The results are shown in Table 5.

(Production Example of Photosensitive Member D-1)

An electrophotographic photosensitive member was produced in the same manner as in Production Example of Photosensitive member A-1 except that instead of the mold used in Production Example of Photosensitive member A-1, a mold having projected portions each having the shape generally illustrated in FIG. 6D and different longest diameters disposed (a first projected portion: the longest diameter Xm: 70 μm, a distance (an interval) Y1: 126 μm, a distance (an interval) Y2: 149 μm, a second projected portion: the longest diameter Xm: 50 μm, a distance (an interval) Y3: 90 μm, a distance (an interval) Y4: 107 μm were respectively disposed; the detail is shown in Table 6) was used as the mold. The obtained electrophotographic photosensitive member having the depressed portions on the surface thereof is referred to as “Photosensitive member D-1.”

The surface of the obtained electrophotographic photosensitive member was observed in the same manner as in Production Example of Photosensitive member A-1. The results are shown in Table 6.

TABLE 1

| | | | | Surface of electrophotographic photosensitive member | | | | | | |
|---|---|---|---|---|---|---|---|---|---|---|
| Electro- | Mold | | | | Area of | | Opening longest | Depth of | | |
| photographic | Longest | | | Temperature | specific | Area of | diameter of | specific | Proportion | Standard |
| photo- | diameter | Distance | Height | during | depressed | flat | specific depressed | depressed | of area of | deviation |
| sensitive | (Xm) | (Y1, Y2) | (H) | processing | portion | part | portion | portion | narrow area | of S |
| member | [μm] | [μm] | [μm] | [° C.] | [μm²] | [μm²] | [μm] | [μm] | [%] | [%] |
| A-1 | 50 | 64, 77 | 2 | 110 | 40000 | 180000 | 50 | 2 | 10 | 1 |
| A-2 | 50 | 148, 171 | 2 | 110 | 10000 | 220000 | 50 | 2 | 5 | 2 |
| A-3 | 50 | 90, 106 | 2 | 110 | 30000 | 200000 | 50 | 2 | 10 | 1 |
| A-4 | 40 | 72, 85 | 2 | 110 | 30000 | 200000 | 40 | 2 | 10 | 1 |
| A-5 | 40 | 72, 85 | 2 | 110 | 30000 | 170000 | 40 | 2 | 10 | 1 |
| A-6 | 40 | 52, 63 | 2 | 110 | 40000 | 200000 | 40 | 2 | 10 | 1 |
| A-7 | 50 | 90, 106 | 3 | 110 | 30000 | 180000 | 50 | 3 | 10 | 1 |
| A-8 | 50 | 64, 77 | 1 | 110 | 40000 | 180000 | 50 | 0.5 | 10 | 1 |
| A-9 | 50 | 148, 171 | 5 | 110 | 10000 | 220000 | 50 | 5 | 5 | 2 |
| A-10 | 50 | 90, 106 | 1 | 110 | 30000 | 200000 | 50 | 0.5 | 10 | 1 |
| A-11 | 70 | 207, 240 | 1 | 110 | 10000 | 200000 | 70 | 0.5 | 11 | 4 |
| A-12 | 25 | 32, 39 | 2 | 110 | 40000 | 150000 | 25 | 2 | 30 | 1 |
| A-13 | 80 | 40, 54 | 5 | 110 | 90000 | 140000 | 80 | 2 | 10 | 1 |
| A-14 | 50 | 64, 77 | 5 | 110 | 40000 | 180000 | 50 | 5 | 10 | 1 |
| A-15 | 50 | 42, 53 | 1 | 110 | 60000 | 160000 | 50 | 1 | 25 | 1 |
| A-16 | 40 | 34, 43 | 1 | 110 | 60000 | 170000 | 40 | 0.5 | 28 | 1 |
| A-17 | 80 | 237, 274 | 3 | 110 | 10000 | 190000 | 80 | 3 | 10 | 3 |
| A-18 | 20 | 10, 13 | 5 | 110 | 90000 | 100000 | 20 | 5 | 65 | 9 |
| A-19 | 50 | 25, 34 | 1 | 110 | 90000 | 90000 | 50 | 1 | 57 | 1 |
| A-20 | 20 | 82, 94 | 1 | 110 | 10000 | 230000 | 20 | 0.5 | 25 | 1 |
| A-21 | 20 | 82, 94 | 1 | 110 | 10000 | 230000 | 20 | 1 | 25 | 1 |
| A-22 | 20 | 82, 94 | 5 | 110 | 10000 | 230000 | 20 | 5 | 10 | 1 |
| A-23 | 50 | 64, 77 | 2 | 110 | 40000 | 180000 | 50 | 2 | 10 | 1 |
| A-24 | 50 | 64, 77 | 2 | 110 | 40000 | 180000 | 50 | 2 | 10 | 1 |
| A-25 | 50 | 64, 77 | 2 | 110 | 40000 | 180000 | 50 | 2 | 10 | 1 |
| A-26 | 80 | 20, 20 | 5 | 110 | 60000 | 170000 | 30 | 0.5 | 50 | 6 |
| A-27 | 50 | 64, 77 | 2 | 110 | 40000 | 180000 | 50 | 2 | 10 | 1 |
| A-28 | 50 | 64, 77 | 3 | 160 | 40000 | 180000 | 50 | 2 | 10 | 1 |
| A-29 | 50 | 148, 171 | 2 | 160 | 10000 | 220000 | 50 | 0.5 | 5 | 2 |
| A-30 | 20 | 26, 31 | 4 | 160 | 40000 | 180000 | 20 | 2 | 10 | 1 |
| A-31 | 60 | 54, 67 | 5 | 110 | 40000 | 180000 | 50 | 1 | 10 | 1 |
| A-32 | 50 | 64, 77 | 2 | 110 | 40000 | 180000 | 50 | 2 | 10 | 1 |

TABLE 2

| | | | | Surface of electrophotographic photosensitive member | | | | | | |
|---|---|---|---|---|---|---|---|---|---|---|
| Electro- | Mold | | | | Area of | | Opening longest | Depth of | | |
| photographic | Longest | | | Temperature | specific | Area of | diameter of | specific | Proportion | Standard |
| photo- | diameter | Distance | Height | during | depressed | flat | specific depressed | depressed | of area of | deviation |
| sensitive | (Xm) | (Y1, Y2) | (H) | processing | portion | part | portion | portion | narrow area | of S |
| member | [μm] | [μm] | [μm] | [° C.] | [μm²] | [μm²] | [μm] | [μm] | [%] | [%] |
| A-33 | 20 | 82, 94 | 1 | 135 | 10000 | 80000 | 20 | 0.5 | 40 | 10 |
| A-34 | 20 | 82, 94 | 1 | 150 | 10000 | 80000 | 20 | 0.5 | 30 | 7 |
| A-35 | 20 | 82, 94 | 1 | 110 | 10000 | 80000 | 20 | 0.5 | 30 | 5 |
| A-36 | 20 | 82, 94 | 5 | 135 | 10000 | 80000 | 20 | 5 | 40 | 10 |
| A-37 | 20 | 82, 94 | 6 | 150 | 10000 | 80000 | 20 | 5 | 30 | 7 |
| A-38 | 20 | 82, 94 | 5 | 110 | 10000 | 80000 | 20 | 5 | 30 | 5 |
| A-39 | 80 | 329, 378 | 1 | 135 | 10000 | 80000 | 80 | 0.5 | 40 | 10 |
| A-40 | 80 | 329, 378 | 1 | 150 | 10000 | 80000 | 80 | 0.5 | 30 | 7 |
| A-41 | 80 | 329, 378 | 1 | 110 | 10000 | 80000 | 80 | 0.5 | 30 | 5 |
| A-42 | 80 | 329, 378 | 5 | 135 | 10000 | 80000 | 80 | 5 | 40 | 10 |
| A-43 | 80 | 329, 378 | 6 | 150 | 10000 | 80000 | 80 | 5 | 30 | 7 |
| A-44 | 80 | 329, 378 | 5 | 110 | 10000 | 80000 | 80 | 5 | 30 | 5 |
| A-45 | 20 | 82, 94 | 1 | 135 | 10000 | 230000 | 20 | 0.5 | 40 | 10 |
| A-46 | 20 | 82, 94 | 1 | 150 | 10000 | 230000 | 20 | 0.5 | 30 | 7 |
| A-47 | 20 | 82, 94 | 1 | 110 | 10000 | 230000 | 20 | 0.5 | 30 | 5 |
| A-48 | 20 | 82, 94 | 5 | 135 | 10000 | 230000 | 20 | 5 | 40 | 10 |
| A-49 | 20 | 82, 94 | 6 | 150 | 10000 | 230000 | 20 | 5 | 30 | 7 |
| A-50 | 20 | 82, 94 | 5 | 110 | 10000 | 230000 | 20 | 5 | 30 | 5 |
| A-51 | 80 | 329, 378 | 1 | 135 | 10000 | 230000 | 80 | 0.5 | 40 | 10 |
| A-52 | 80 | 329, 378 | 1 | 150 | 10000 | 230000 | 80 | 0.5 | 30 | 7 |
| A-53 | 80 | 329, 378 | 1 | 110 | 10000 | 230000 | 80 | 0.5 | 30 | 5 |
| A-54 | 80 | 329, 378 | 5 | 135 | 10000 | 230000 | 80 | 5 | 40 | 10 |
| A-55 | 80 | 329, 378 | 6 | 150 | 10000 | 230000 | 80 | 5 | 30 | 7 |
| A-56 | 80 | 329, 378 | 5 | 110 | 10000 | 230000 | 80 | 5 | 30 | 5 |
| A-57 | 20 | 10, 13 | 1 | 135 | 90000 | 80000 | 20 | 0.5 | 40 | 10 |
| A-58 | 20 | 10, 13 | 1 | 150 | 90000 | 80000 | 20 | 0.5 | 30 | 7 |
| A-59 | 20 | 10, 13 | 1 | 110 | 90000 | 80000 | 20 | 0.5 | 30 | 5 |
| A-60 | 20 | 10, 13 | 5 | 135 | 90000 | 80000 | 20 | 5 | 40 | 10 |
| A-61 | 20 | 10, 13 | 5 | 110 | 90000 | 80000 | 20 | 5 | 30 | 7 |
| A-62 | 20 | 10, 13 | 5 | 100 | 90000 | 80000 | 20 | 5 | 30 | 5 |
| A-63 | 80 | 40, 54 | 1 | 135 | 90000 | 80000 | 80 | 0.5 | 40 | 10 |
| A-64 | 80 | 40, 54 | 1 | 150 | 90000 | 80000 | 80 | 0.5 | 30 | 7 |

TABLE 3

| | | | | Surface of electrophotographic photosensitive member | | | | | | |
|---|---|---|---|---|---|---|---|---|---|---|
| Electro- | Mold | | | | Area of | | Opening longest | Depth of | | |
| photographic | Longest | | | Temperature | specific | Area of | diameter of | specific | Proportion | Standard |
| photo- | diameter | Distance | Height | during | depressed | flat | specific depressed | depressed | of area of | deviation |
| sensitive | (Xm) | (Y1, Y2) | (H) | processing | portion | part | portion | portion | narrow area | of S |
| member | [μm] | [μm] | [μm] | [° C.] | [μm²] | [μm²] | [μm] | [μm] | [%] | [%] |
| A-65 | 80 | 40, 54 | 1 | 110 | 90000 | 80000 | 80 | 0.5 | 30 | 5 |
| A-66 | 80 | 40, 54 | 5 | 135 | 90000 | 80000 | 80 | 5 | 40 | 10 |
| A-67 | 80 | 40, 54 | 6 | 150 | 90000 | 80000 | 80 | 5 | 30 | 7 |
| A-68 | 80 | 40, 54 | 5 | 110 | 90000 | 80000 | 80 | 5 | 30 | 5 |
| A-69 | 20 | 10, 13 | 1 | 135 | 90000 | 140000 | 20 | 0.5 | 40 | 10 |
| A-70 | 20 | 10, 13 | 1 | 150 | 90000 | 140000 | 20 | 0.5 | 30 | 7 |
| A-71 | 20 | 10, 13 | 1 | 110 | 90000 | 140000 | 20 | 0.5 | 30 | 5 |
| A-72 | 20 | 10, 13 | 5 | 135 | 90000 | 140000 | 20 | 5 | 40 | 10 |
| A-73 | 20 | 10, 13 | 6 | 150 | 90000 | 140000 | 20 | 5 | 30 | 7 |
| A-74 | 20 | 10, 13 | 5 | 110 | 90000 | 140000 | 20 | 5 | 30 | 5 |
| A-75 | 80 | 40, 54 | 1 | 135 | 90000 | 140000 | 80 | 0.5 | 40 | 10 |
| A-76 | 80 | 40, 54 | 1 | 150 | 90000 | 140000 | 80 | 0.5 | 30 | 7 |
| A-77 | 80 | 40, 54 | 1 | 110 | 90000 | 140000 | 80 | 0.5 | 30 | 5 |
| A-78 | 80 | 40, 54 | 5 | 135 | 90000 | 140000 | 80 | 5 | 40 | 10 |
| A-79 | 80 | 40, 54 | 6 | 150 | 90000 | 140000 | 80 | 5 | 30 | 7 |
| A-80 | 80 | 40, 54 | 5 | 110 | 90000 | 140000 | 80 | 5 | 30 | 5 |

TABLE 4

| | | | | Surface of electrophotographic photosensitive member | | | | | | |
|---|---|---|---|---|---|---|---|---|---|---|
| Electro- | Mold | | | | Area of | | Opening longest | Depth of | | |
| photographic | Longest | | | Temperature | specific | Area of | diameter of | specific | Proportion | Standard |
| photo- | diameter | Distance | Height | during | depressed | flat | specific depressed | depressed | of area of | deviation |
| sensitive | (Xm) | (Y1, Y2) | (H) | processing | portion | part | portion | portion | narrow area | of S |
| member | [μm] | [μm] | [μm] | [° C.] | [μm²] | [μm²] | [μm] | [μm] | [%] | [%] |
| B-1 | 50 | — | 3 | 110 | 40000 | 150000 | 50 | 3 | 10 | 2 |
| B-2 | 40 | — | 1 | 110 | 40000 | 140000 | 40 | 1 | 10 | 2 |
| B-3 | 40 | — | 2 | 110 | 30000 | 160000 | 40 | 2 | 7 | 2 |
| B-4 | 50 | — | 3 | 110 | 40000 | 150000 | 50 | 3 | 10 | 2 |
| B-5 | 50 | — | 5 | 110 | 40000 | 140000 | 50 | 5 | 10 | 2 |
| B-6 | 40 | — | 1 | 110 | 30000 | 160000 | 40 | 0.5 | 7 | 2 |
| B-7 | 50 | — | 2 | 110 | 40000 | 150000 | 50 | 2 | 10 | 2 |
| B-8 | 50 | — | 3 | 110 | 30000 | 180000 | 50 | 3 | 10 | 2 |
| B-9 | 50 | — | 4 | 110 | 10000 | 220000 | 50 | 4 | 5 | 2 |
| B-10 | 50 | — | 3 | 110 | 10000 | 220000 | 50 | 3 | 5 | 2 |

TABLE 5

| | | | | | Surface of electrophotographic photosensitive member | | | | | | |
|---|---|---|---|---|---|---|---|---|---|---|---|
| | | | | | | | | Opening | | | |
| | | | | | | | | longest | | | |
| Electro- | Mold | | | | | Area of | | diameter of | Depth of | | |
| photographic | Longest | | | | Temperature | specific | Area of | specific | specific | Proportion | Standard |
| photo- | diameter | Distance | Distance | Height | during | depressed | flat | depressed | depressed | of area of | deviation |
| sensitive | (Xm) | (Y1, Y2) | (Y3, Y4) | (H) | processing | portion | part | portion | portion | narrow area | of S |
| member | [μm] | [μm] | [μm] | [μm] | [° C.] | [μm²] | [μm²] | [μm] | [μm] | [%] | [%] |
| C-1 | 50 | 64, 77 | 25, 34 | 2 | 110 | 40000~ | 130000~ | 50 | 2 | 44 | 23 |
| | | | | | | 90000 | 180000 | | | | |
| C-2 | 50 | 148, 172 | 64, 78 | 2 | 110 | 10000~ | 180000 [symbol] ~ | 50 | 2 | 7.5 | 2.5 |
| | | | | | | 40000 | 220000 | | | | |
| C-3 | 40 | 52, 62 | 34, 43 | 1 | 110 | 40000~ | 160000~ | 40 | 1 | 18 | 9 |
| | | | | | | 60000 | 180000 | | | | |

TABLE 6

| | | | | | Surface of electrophotographic photosensitive member | | | | | | |
|---|---|---|---|---|---|---|---|---|---|---|---|
| | | | | | | | | Opening | | | |
| | | | | | | | | longest | | | |
| Electro- | Mold | | | | | Area of | | diameter of | Depth of | | |
| photographic | Longest | | | | Temperature | specific | Area of | specific | specific | Proportion | Standard |
| photo- | diameter | Distance | Distance | Height | during | depressed | flat | depressed | depressed | of area of | deviation |
| sensitive | (Xm) | (Y1, Y2) | (Y3, Y4) | (H) | processing | portion | part | portion | portion | narrow area | of S |
| member | [μm] | [μm] | [μm] | [μm] | [° C.] | [μm²] | [μm²] | [μm] | [μm] | [%] | [%] |
| D-1 | 50/70 | 126, 149 | 90, 107 | 2 | 110 | 30000 | 200000 | 50/70 | 2 | 7 | 3 |

(Evaluation of Electrophotographic Photosensitive Member Using Actual Machine)

### Example 1

Photosensitive member A-1 was mounted on a cyan station in a modified electrophotographic apparatus (copier) (trade name: iR-ADV C7055) made by Canon Inc. as an evaluation apparatus, and a test and evaluation were performed as follows.

First, under an environment of 30° C./80% RH, conditions of the charging apparatus and the image exposure apparatus were set such that the dark potential (Vd) of the electrophotographic photosensitive member was −700 V and the bright potential (Vl) was −200 V, and an initial potential of the electrophotographic photosensitive member was adjusted.

Next, setting was performed such that a cleaning blade made of a polyurethane rubber having a hardness of 77° was abutted to the surface of the electrophotographic photosensitive member at an abut angle of 28° and an abut pressure of 30 g/cm. In the state where a heater for the electrophotographic photosensitive member (drum heater) was turned OFF, 50000 sheets of an evaluation chart having an A4 horizontal 5% image were continuously output under an environment of 30° C./80% RH. The electrophotographic apparatus was left for three days under an environment of 30° C./80% RH in the state where the power supply was off.

After the electrophotographic apparatus was left for three days, the electrophotographic apparatus was started to form an A4 horizontal one dot-one space image with an output resolution of 600 dpi, and the concentration of the image in the portion corresponding to the vicinity of the charging apparatus and an image reproductivity of the A4 whole surface were evaluated as follows. The results are shown in Table 7.

A: no irregularities and scattering of dots (namely, no image deletion) is found in the portion corresponding to the vicinity of the charging apparatus, and the image reproductivity is good.

B: irregularities of the dots are slightly found in the portion corresponding to the vicinity of the charging apparatus when the output image is enlarged and observed, while no scattering is found; the image reproductivity is good in other portion.

C: irregularities and scattering of the dots are produced somewhat in the portion corresponding to the vicinity of the charging apparatus, when the output image is enlarged and observed, but the image reproductivity is good in other portion.

D: irregularities and scattering of the dots are produced in the portion corresponding to the vicinity of the charging apparatus when the output image is enlarged and observed, but the image reproductivity is good in other portion.

E: white blanks on the image are found in the portion corresponding to the vicinity of the charging apparatus, and the image reproductivity is somewhat poor in other portion.

### Examples 2 to 384

The electrophotographic photosensitive members were evaluated by the actual machine in the same manner as in Example 1 except that those shown in Tables 7 to 16 were used as the electrophotographic photosensitive members and the hardness and setting (the abut angle and the abut pressure) of the cleaning blade were as shown in Tables 7 to 16. The results are shown in Tables 7 to 16.

### Examples 1001 to 1020

The electrophotographic photosensitive members were evaluated in the same manner as in Example 1 by the actual machine except that a modified electrophotographic apparatus (POD machine) made by Canon Inc. (trade name: image PRESS C7000VP (corona charging method)) was used as an evaluation apparatus (the electrophotographic photosensitive member was mounted on the cyan station), those shown in Table 17 were used as the electrophotographic photosensitive members, and the hardness and setting (the abut angle and the abut pressure) of the cleaning blade were as shown in Table 17. The results are shown in Table 17.

### Examples 2001 to 2019

The electrophotographic photosensitive members were evaluated in the same manner as in Example 1 by the actual machine except that a modified electrophotographic apparatus (laser beam printer) (trade name: Color LaserJet Enterprise CP4525dn) made by Hewlett-Packard Company was used as an evaluation apparatus (the electrophotographic photosensitive member was mounted on the cyan station), the environment for evaluation and the environment in which the electrophotographic apparatus was left for three days were changed from the 30° C./80% RH environment to the 35° C./85% RH environment, the number of the evaluation chart to be continuously output was changed from 50000 sheets to 10000 sheets, those shown in Table 18 were used as the electrophotographic photosensitive members, and the hardness and setting (the abut angle and the abut pressure) of the cleaning blade were as shown in Table 18. The results are shown in Table 18.

### Examples 3001 to 3009

The electrophotographic photosensitive members were evaluated in the same manner as in Example 1 by the actual machine except that a modified electrophotographic apparatus (laser beam printer) (trade name: LaserJet Enterprise P3015dn) made by Hewlett-Packard Company was used as an evaluation apparatus (the electrophotographic photosensitive member was mounted on the cyan station), the environment for evaluation and the environment in which the electrophotographic apparatus was left for three days were changed from the 30° C./80% RH environment to the 35° C./85% RH environment, the number of the evaluation chart to be continuously output was changed from 50000 sheets to 10000 sheets, those shown in Table 19 were used as the electrophotographic photosensitive members, and the hardness and setting (the abut angle and the abut pressure) of the cleaning blade were as shown in Table 19. The results are shown in Table 19.

TABLE 7

| | Electro- | Cleaning blade | | | |
|---|---|---|---|---|---|
| | photographic | | Contact | Contact | |
| | photosensitive | Hardness | angle | pressure | Results of |
| | member | [°] | [°] | [g/cm] | evaluation |
| Example 1 | A-1 | 77 | 28 | 30 | A |
| Example 2 | A-2 | 77 | 28 | 30 | A |
| Example 3 | A-3 | 77 | 28 | 30 | A |
| Example 4 | A-4 | 77 | 28 | 30 | A |
| Example 5 | A-6 | 77 | 28 | 30 | A |
| Example 6 | A-7 | 77 | 28 | 30 | A |
| Example 7 | A-8 | 77 | 28 | 30 | B |
| Example 8 | A-9 | 77 | 28 | 30 | A |
| Example 9 | A-10 | 77 | 28 | 30 | B |
| Example 10 | A-11 | 77 | 28 | 30 | B |
| Example 11 | A-12 | 77 | 28 | 30 | A |
| Example 12 | A-13 | 77 | 28 | 30 | A |
| Example 13 | A-14 | 77 | 28 | 30 | A |
| Example 14 | A-15 | 77 | 28 | 30 | A |
| Example 15 | A-16 | 77 | 28 | 30 | B |
| Example 16 | A-17 | 77 | 28 | 30 | A |
| Example 17 | A-18 | 77 | 28 | 30 | C |
| Example 18 | A-19 | 77 | 28 | 30 | B |
| Example 19 | A-20 | 77 | 28 | 30 | B |
| Example 20 | A-21 | 77 | 28 | 30 | A |
| Example 21 | A-22 | 77 | 28 | 30 | A |
| Example 22 | A-23 | 77 | 28 | 30 | A |
| Example 23 | A-25 | 77 | 28 | 30 | B |
| Example 24 | A-26 | 77 | 28 | 30 | D |
| Example 25 | A-28 | 77 | 28 | 30 | A |
| Example 26 | A-29 | 77 | 28 | 30 | B |
| Example 27 | A-30 | 77 | 28 | 30 | A |
| Example 28 | A-31 | 77 | 28 | 30 | A |
| Example 29 | A-32 | 77 | 28 | 30 | A |
| Example 30 | B-2 | 77 | 28 | 30 | A |
| Example 31 | B-3 | 77 | 28 | 30 | A |
| Example 32 | B-4 | 77 | 28 | 30 | A |
| Example 33 | B-5 | 77 | 28 | 30 | A |
| Example 34 | B-6 | 77 | 28 | 30 | B |
| Example 35 | B-8 | 77 | 28 | 30 | A |
| Example 36 | C-1 | 77 | 28 | 30 | C |
| Example 37 | C-2 | 77 | 28 | 30 | A |
| Example 38 | C-3 | 77 | 28 | 30 | B |
| Example 39 | D-1 | 77 | 28 | 30 | A |
| Example 40 | A-1 | 65 | 28 | 30 | A |

TABLE 8

| | Electro- | Cleaning blade | | | |
|---|---|---|---|---|---|
| | photographic | | Contact | Contact | |
| | photosensitive | Hardness | angle | pressure | Results of |
| | member | [°] | [°] | [g/cm] | evaluation |
| Example 41 | A-2 | 65 | 28 | 30 | A |
| Example 42 | A-6 | 65 | 28 | 15 | A |
| Example 43 | A-8 | 65 | 28 | 30 | B |
| Example 44 | A-9 | 65 | 28 | 30 | A |
| Example 45 | A-32 | 65 | 28 | 30 | A |
| Example 46 | A-14 | 65 | 28 | 30 | A |
| Example 47 | A-16 | 65 | 28 | 30 | B |
| Example 48 | A-18 | 65 | 28 | 30 | C |
| Example 49 | A-19 | 65 | 28 | 30 | B |
| Example 50 | A-20 | 65 | 28 | 30 | B |
| Example 51 | B-2 | 65 | 28 | 30 | A |
| Example 52 | B-3 | 65 | 28 | 30 | A |
| Example 53 | B-4 | 65 | 28 | 30 | A |
| Example 54 | A-1 | 80 | 28 | 15 | A |
| Example 55 | A-2 | 80 | 28 | 30 | A |
| Example 56 | A-6 | 80 | 28 | 30 | A |
| Example 57 | A-32 | 80 | 28 | 30 | A |
| Example 58 | A-14 | 80 | 28 | 30 | A |
| Example 59 | A-16 | 80 | 28 | 30 | B |
| Example 60 | A-18 | 80 | 28 | 30 | C |
| Example 61 | A-19 | 80 | 28 | 30 | B |
| Example 62 | A-20 | 80 | 28 | 30 | B |
| Example 63 | B-2 | 80 | 28 | 15 | A |
| Example 64 | B-3 | 80 | 28 | 30 | A |
| Example 65 | B-4 | 80 | 28 | 30 | A |
| Example 66 | A-1 | 77 | 28 | 45 | A |
| Example 67 | B-8 | 77 | 28 | 30 | A |
| Example 68 | A-28 | 65 | 28 | 30 | A |
| Example 69 | A-30 | 65 | 28 | 30 | A |
| Example 70 | A-31 | 65 | 28 | 30 | A |
| Example 71 | A-28 | 80 | 28 | 30 | A |
| Example 72 | A-30 | 80 | 28 | 30 | A |
| Example 73 | A-31 | 80 | 28 | 30 | A |
| Example 74 | A-32 | 77 | 28 | 45 | A |
| Example 75 | A-32 | 77 | 28 | 15 | A |
| Example 76 | A-1 | 77 | 20 | 30 | A |
| Example 77 | A-7 | 77 | 28 | 15 | A |
| Example 78 | A-1 | 77 | 28 | 15 | A |
| Example 79 | A-33 | 65 | 28 | 15 | D |
| Example 80 | A-34 | 65 | 28 | 15 | C |

TABLE 9

| | Electro- | Cleaning blade | | | |
|---|---|---|---|---|---|
| | photographic | | Contact | Contact | |
| | photosensitive | Hardness | angle | pressure | Results of |
| | member | [°] | [°] | [g/cm] | evaluation |
| Example 81 | A-35 | 65 | 28 | 15 | B |
| Example 82 | A-36 | 65 | 28 | 15 | C |
| Example 83 | A-37 | 65 | 28 | 15 | B |
| Example 84 | A-38 | 65 | 28 | 15 | A |
| Example 85 | A-39 | 65 | 28 | 15 | D |
| Example 86 | A-40 | 65 | 28 | 15 | C |
| Example 87 | A-41 | 65 | 28 | 15 | B |
| Example 88 | A-42 | 65 | 28 | 15 | C |
| Example 89 | A-43 | 65 | 28 | 15 | B |
| Example 90 | A-44 | 65 | 28 | 15 | A |
| Example 91 | A-45 | 65 | 28 | 15 | D |
| Example 92 | A-46 | 65 | 28 | 15 | C |
| Example 93 | A-47 | 65 | 28 | 15 | B |
| Example 94 | A-48 | 65 | 28 | 15 | C |
| Example 95 | A-49 | 65 | 28 | 15 | B |
| Example 96 | A-50 | 65 | 28 | 15 | A |
| Example 97 | A-51 | 65 | 28 | 15 | D |
| Example 98 | A-52 | 65 | 28 | 15 | C |
| Example 99 | A-53 | 65 | 28 | 15 | B |
| Example 100 | A-54 | 65 | 28 | 15 | C |
| Example 101 | A-55 | 65 | 28 | 15 | B |
| Example 102 | A-56 | 65 | 28 | 15 | A |
| Example 103 | A-57 | 65 | 28 | 15 | D |
| Example 104 | A-58 | 65 | 28 | 15 | C |
| Example 105 | A-59 | 65 | 28 | 15 | B |
| Example 106 | A-60 | 65 | 28 | 15 | C |
| Example 107 | A-61 | 65 | 28 | 15 | B |
| Example 108 | A-62 | 65 | 28 | 15 | A |
| Example 109 | A-63 | 65 | 28 | 15 | D |
| Example 110 | A-64 | 65 | 28 | 15 | C |
| Example 111 | A-65 | 65 | 28 | 15 | B |
| Example 112 | A-66 | 65 | 28 | 15 | C |
| Example 113 | A-67 | 65 | 28 | 15 | B |
| Example 114 | A-68 | 65 | 28 | 15 | A |
| Example 115 | A-69 | 65 | 28 | 15 | D |
| Example 116 | A-70 | 65 | 28 | 15 | C |
| Example 117 | A-71 | 65 | 28 | 15 | B |
| Example 118 | A-72 | 65 | 28 | 15 | C |
| Example 119 | A-73 | 65 | 28 | 15 | B |
| Example 120 | A-74 | 65 | 28 | 15 | A |

TABLE 10

| | Electro- | Cleaning blade | | | |
|---|---|---|---|---|---|
| | photographic | | Contact | Contact | |
| | photosensitive | Hardness | angle | pressure | Results of |
| | member | [°] | [°] | [g/cm] | evaluation |
| Example 121 | A-75 | 65 | 28 | 15 | D |
| Example 122 | A-76 | 65 | 28 | 15 | C |
| Example 123 | A-77 | 65 | 28 | 15 | B |
| Example 124 | A-78 | 65 | 28 | 15 | C |
| Example 125 | A-79 | 65 | 28 | 15 | B |
| Example 126 | A-80 | 65 | 28 | 15 | A |
| Example 127 | A-33 | 80 | 28 | 45 | D |
| Example 128 | A-34 | 80 | 28 | 45 | C |
| Example 129 | A-35 | 80 | 28 | 45 | B |
| Example 130 | A-36 | 80 | 28 | 45 | C |
| Example 131 | A-37 | 80 | 28 | 45 | B |
| Example 132 | A-38 | 80 | 28 | 45 | A |
| Example 133 | A-39 | 80 | 28 | 45 | D |
| Example 134 | A-40 | 80 | 28 | 45 | C |
| Example 135 | A-41 | 80 | 28 | 45 | B |
| Example 136 | A-42 | 80 | 28 | 45 | C |
| Example 137 | A-43 | 80 | 28 | 45 | B |
| Example 138 | A-44 | 80 | 28 | 45 | A |
| Example 139 | A-45 | 80 | 28 | 45 | D |
| Example 140 | A-46 | 80 | 28 | 45 | C |
| Example 141 | A-47 | 80 | 28 | 45 | B |
| Example 142 | A-48 | 80 | 28 | 45 | C |
| Example 143 | A-49 | 80 | 28 | 45 | B |
| Example 144 | A-50 | 80 | 28 | 45 | A |
| Example 145 | A-51 | 80 | 28 | 45 | D |
| Example 146 | A-52 | 80 | 28 | 45 | C |
| Example 147 | A-53 | 80 | 28 | 45 | B |
| Example 148 | A-54 | 80 | 28 | 45 | C |
| Example 149 | A-55 | 80 | 28 | 45 | B |
| Example 150 | A-56 | 80 | 28 | 45 | A |
| Example 151 | A-57 | 80 | 28 | 45 | D |
| Example 152 | A-58 | 80 | 28 | 45 | C |
| Example 153 | A-59 | 80 | 28 | 45 | B |
| Example 154 | A-60 | 80 | 28 | 45 | C |
| Example 155 | A-61 | 80 | 28 | 45 | B |
| Example 156 | A-62 | 80 | 28 | 45 | A |
| Example 157 | A-63 | 80 | 28 | 45 | D |
| Example 158 | A-64 | 80 | 28 | 45 | C |
| Example 159 | A-65 | 80 | 28 | 45 | B |
| Example 160 | A-66 | 80 | 28 | 45 | C |

TABLE 11

| | Electro- | Cleaning blade | | | |
|---|---|---|---|---|---|
| | photographic | | Contact | Contact | |
| | photosensitive | Hardness | angle | pressure | Results of |
| | member | [°] | [°] | [g/cm] | evaluation |
| Example 161 | A-67 | 80 | 28 | 45 | B |
| Example 162 | A-68 | 80 | 28 | 45 | A |
| Example 163 | A-69 | 80 | 28 | 45 | D |
| Example 164 | A-70 | 80 | 28 | 45 | C |
| Example 165 | A-71 | 80 | 28 | 45 | B |
| Example 166 | A-72 | 80 | 28 | 45 | C |
| Example 167 | A-73 | 80 | 28 | 45 | B |
| Example 168 | A-74 | 80 | 28 | 45 | A |
| Example 169 | A-75 | 80 | 28 | 45 | D |
| Example 170 | A-76 | 80 | 28 | 45 | C |
| Example 171 | A-77 | 80 | 28 | 45 | B |
| Example 172 | A-78 | 80 | 28 | 45 | C |
| Example 173 | A-79 | 80 | 28 | 45 | B |
| Example 174 | A-80 | 80 | 28 | 45 | A |
| Example 175 | A-33 | 65 | 28 | 45 | D |
| Example 176 | A-34 | 65 | 28 | 45 | C |
| Example 177 | A-35 | 65 | 28 | 45 | B |
| Example 178 | A-36 | 65 | 28 | 45 | C |
| Example 179 | A-37 | 65 | 28 | 45 | B |
| Example 180 | A-38 | 65 | 28 | 45 | A |
| Example 181 | A-39 | 65 | 28 | 45 | D |
| Example 182 | A-40 | 65 | 28 | 45 | C |
| Example 183 | A-41 | 65 | 28 | 45 | B |
| Example 184 | A-42 | 65 | 28 | 45 | C |
| Example 185 | A-43 | 65 | 28 | 45 | B |
| Example 186 | A-44 | 65 | 28 | 45 | A |
| Example 187 | A-45 | 65 | 28 | 45 | D |
| Example 188 | A-46 | 65 | 28 | 45 | C |
| Example 189 | A-47 | 65 | 28 | 45 | B |
| Example 190 | A-48 | 65 | 28 | 45 | C |
| Example 191 | A-49 | 65 | 28 | 45 | B |
| Example 192 | A-50 | 65 | 28 | 45 | A |
| Example 193 | A-51 | 65 | 28 | 45 | D |
| Example 194 | A-52 | 65 | 28 | 45 | C |
| Example 195 | A-53 | 65 | 28 | 45 | B |
| Example 196 | A-54 | 65 | 28 | 45 | C |
| Example 197 | A-55 | 65 | 28 | 45 | B |
| Example 198 | A-56 | 65 | 28 | 45 | A |
| Example 199 | A-57 | 65 | 28 | 45 | D |
| Example 200 | A-58 | 65 | 28 | 45 | C |

TABLE 12

| | Electro- | Cleaning blade | | | |
|---|---|---|---|---|---|
| | photographic | | Contact | Contact | |
| | photosensitive | Hardness | angle | pressure | Results of |
| | member | [°] | [°] | [g/cm] | evaluation |
| Example 201 | A-59 | 65 | 28 | 45 | B |
| Example 202 | A-60 | 65 | 28 | 45 | C |
| Example 203 | A-61 | 65 | 28 | 45 | B |
| Example 204 | A-62 | 65 | 28 | 45 | A |
| Example 205 | A-63 | 65 | 28 | 45 | D |
| Example 206 | A-64 | 65 | 28 | 45 | C |
| Example 207 | A-65 | 65 | 28 | 45 | B |
| Example 208 | A-66 | 65 | 28 | 45 | C |
| Example 209 | A-67 | 65 | 28 | 45 | B |
| Example 210 | A-68 | 65 | 28 | 45 | A |
| Example 211 | A-69 | 65 | 28 | 45 | D |
| Example 212 | A-70 | 65 | 28 | 45 | C |
| Example 213 | A-71 | 65 | 28 | 45 | B |
| Example 214 | A-72 | 65 | 28 | 45 | C |
| Example 215 | A-73 | 65 | 28 | 45 | B |
| Example 216 | A-74 | 65 | 28 | 45 | A |
| Example 217 | A-75 | 65 | 28 | 45 | D |
| Example 218 | A-76 | 65 | 28 | 45 | C |
| Example 219 | A-77 | 65 | 28 | 45 | B |
| Example 220 | A-78 | 65 | 28 | 45 | C |
| Example 221 | A-79 | 65 | 28 | 45 | B |
| Example 222 | A-80 | 65 | 28 | 45 | A |
| Example 223 | A-33 | 80 | 28 | 15 | D |
| Example 224 | A-34 | 80 | 28 | 15 | C |
| Example 225 | A-35 | 80 | 28 | 15 | B |
| Example 226 | A-36 | 80 | 28 | 15 | C |
| Example 227 | A-37 | 80 | 28 | 15 | B |
| Example 228 | A-38 | 80 | 28 | 15 | A |
| Example 229 | A-39 | 80 | 28 | 15 | D |
| Example 230 | A-40 | 80 | 28 | 15 | C |
| Example 231 | A-41 | 80 | 28 | 15 | B |
| Example 232 | A-42 | 80 | 28 | 15 | C |
| Example 233 | A-43 | 80 | 28 | 15 | B |
| Example 234 | A-44 | 80 | 28 | 15 | A |
| Example 235 | A-45 | 80 | 28 | 15 | D |
| Example 236 | A-46 | 80 | 28 | 15 | C |
| Example 237 | A-47 | 80 | 28 | 15 | B |
| Example 238 | A-48 | 80 | 28 | 15 | C |
| Example 239 | A-49 | 80 | 28 | 15 | B |
| Example 240 | A-50 | 80 | 28 | 15 | A |

TABLE 13

| | Electro- | Cleaning blade | | | |
|---|---|---|---|---|---|
| | photographic | | Contact | Contact | |
| | photosensitive | Hardness | angle | pressure | Results of |
| | member | [°] | [°] | [g/cm] | evaluation |
| Example 241 | A-51 | 80 | 28 | 15 | D |
| Example 242 | A-52 | 80 | 28 | 15 | C |
| Example 243 | A-53 | 80 | 28 | 15 | B |
| Example 244 | A-54 | 80 | 28 | 15 | C |
| Example 245 | A-55 | 80 | 28 | 15 | B |
| Example 246 | A-56 | 80 | 28 | 15 | A |
| Example 247 | A-57 | 80 | 28 | 15 | D |
| Example 248 | A-58 | 80 | 28 | 15 | C |
| Example 249 | A-59 | 80 | 28 | 15 | B |
| Example 250 | A-60 | 80 | 28 | 15 | C |
| Example 251 | A-61 | 80 | 28 | 15 | B |
| Example 252 | A-62 | 80 | 28 | 15 | A |
| Example 253 | A-63 | 80 | 28 | 15 | D |
| Example 254 | A-64 | 80 | 28 | 15 | C |
| Example 255 | A-65 | 80 | 28 | 15 | B |
| Example 256 | A-66 | 80 | 28 | 15 | C |
| Example 257 | A-67 | 80 | 28 | 15 | B |
| Example 258 | A-68 | 80 | 28 | 15 | A |
| Example 259 | A-69 | 80 | 28 | 15 | D |
| Example 260 | A-70 | 80 | 28 | 15 | C |
| Example 261 | A-71 | 80 | 28 | 15 | B |
| Example 262 | A-72 | 80 | 28 | 15 | C |
| Example 263 | A-73 | 80 | 28 | 15 | B |
| Example 264 | A-74 | 80 | 28 | 15 | A |
| Example 265 | A-75 | 80 | 28 | 15 | D |
| Example 266 | A-76 | 80 | 28 | 15 | C |
| Example 267 | A-77 | 80 | 28 | 15 | B |
| Example 268 | A-78 | 80 | 28 | 15 | C |
| Example 269 | A-79 | 80 | 28 | 15 | B |
| Example 270 | A-80 | 80 | 28 | 15 | A |
| Example 271 | A-33 | 77 | 28 | 15 | D |
| Example 272 | A-34 | 77 | 28 | 15 | C |
| Example 273 | A-35 | 77 | 28 | 15 | B |
| Example 274 | A-36 | 77 | 28 | 15 | C |
| Example 275 | A-37 | 77 | 28 | 15 | B |
| Example 276 | A-38 | 77 | 28 | 15 | A |
| Example 277 | A-39 | 77 | 28 | 15 | D |
| Example 278 | A-40 | 77 | 28 | 15 | C |
| Example 279 | A-41 | 77 | 28 | 15 | B |
| Example 280 | A-42 | 77 | 28 | 15 | C |

TABLE 14

| | Electro- | Cleaning blade | | | |
|---|---|---|---|---|---|
| | photographic | | Contact | Contact | |
| | photosensitive | Hardness | angle | pressure | Results of |
| | member | [°] | [°] | [g/cm] | evaluation |
| Example 281 | A-43 | 77 | 28 | 15 | B |
| Example 282 | A-44 | 77 | 28 | 15 | A |
| Example 283 | A-45 | 77 | 28 | 15 | D |
| Example 284 | A-46 | 77 | 28 | 15 | C |
| Example 285 | A-47 | 77 | 28 | 15 | B |
| Example 286 | A-48 | 77 | 28 | 15 | C |
| Example 287 | A-49 | 77 | 28 | 15 | B |
| Example 288 | A-50 | 77 | 28 | 15 | A |
| Example 289 | A-51 | 77 | 28 | 15 | D |
| Example 290 | A-52 | 77 | 28 | 15 | C |
| Example 291 | A-53 | 77 | 28 | 15 | B |
| Example 292 | A-54 | 77 | 28 | 15 | C |
| Example 293 | A-55 | 77 | 28 | 15 | B |
| Example 294 | A-56 | 77 | 28 | 15 | A |
| Example 295 | A-57 | 77 | 28 | 15 | D |
| Example 296 | A-58 | 77 | 28 | 15 | C |
| Example 297 | A-59 | 77 | 28 | 15 | B |
| Example 298 | A-60 | 77 | 28 | 15 | C |
| Example 299 | A-61 | 77 | 28 | 15 | B |
| Example 300 | A-62 | 77 | 28 | 15 | A |
| Example 301 | A-63 | 77 | 28 | 15 | D |
| Example 302 | A-64 | 77 | 28 | 15 | C |
| Example 303 | A-65 | 77 | 28 | 15 | B |
| Example 304 | A-66 | 77 | 28 | 15 | C |
| Example 305 | A-67 | 77 | 28 | 15 | B |
| Example 306 | A-68 | 77 | 28 | 15 | A |
| Example 307 | A-69 | 77 | 28 | 15 | D |
| Example 308 | A-70 | 77 | 28 | 15 | C |
| Example 309 | A-71 | 77 | 28 | 15 | B |
| Example 310 | A-72 | 77 | 28 | 15 | C |
| Example 311 | A-73 | 77 | 28 | 15 | B |
| Example 312 | A-74 | 77 | 28 | 15 | A |
| Example 313 | A-75 | 77 | 28 | 15 | D |
| Example 314 | A-76 | 77 | 28 | 15 | C |
| Example 315 | A-77 | 77 | 28 | 15 | B |
| Example 316 | A-78 | 77 | 28 | 15 | C |
| Example 317 | A-79 | 77 | 28 | 15 | B |
| Example 318 | A-80 | 77 | 28 | 15 | A |
| Example 319 | A-33 | 77 | 28 | 45 | D |
| Example 320 | A-34 | 77 | 28 | 45 | C |

TABLE 15

| | Electro- | Cleaning blade | | | |
|---|---|---|---|---|---|
| | photographic | | Contact | Contact | |
| | photosensitive | Hardness | angle | pressure | Results of |
| | member | [°] | [°] | [g/cm] | evaluation |
| Example 321 | A-35 | 77 | 28 | 45 | B |
| Example 322 | A-36 | 77 | 28 | 45 | C |
| Example 323 | A-37 | 77 | 28 | 45 | B |
| Example 324 | A-38 | 77 | 28 | 45 | A |
| Example 325 | A-39 | 77 | 28 | 45 | D |
| Example 326 | A-40 | 77 | 28 | 45 | C |
| Example 327 | A-41 | 77 | 28 | 45 | B |
| Example 328 | A-42 | 77 | 28 | 45 | C |
| Example 329 | A-43 | 77 | 28 | 45 | B |
| Example 330 | A-44 | 77 | 28 | 45 | A |
| Example 331 | A-45 | 77 | 28 | 45 | D |
| Example 332 | A-46 | 77 | 28 | 45 | C |
| Example 333 | A-47 | 77 | 28 | 45 | B |
| Example 334 | A-48 | 77 | 28 | 45 | C |
| Example 335 | A-49 | 77 | 28 | 45 | B |
| Example 336 | A-50 | 77 | 28 | 45 | A |
| Example 337 | A-51 | 77 | 28 | 45 | D |
| Example 338 | A-52 | 77 | 28 | 45 | C |
| Example 339 | A-53 | 77 | 28 | 45 | B |
| Example 340 | A-54 | 77 | 28 | 45 | C |
| Example 341 | A-55 | 77 | 28 | 45 | B |
| Example 342 | A-56 | 77 | 28 | 45 | A |
| Example 343 | A-57 | 77 | 28 | 45 | D |
| Example 344 | A-58 | 77 | 28 | 45 | C |
| Example 345 | A-59 | 77 | 28 | 45 | B |
| Example 346 | A-60 | 77 | 28 | 45 | C |
| Example 347 | A-61 | 77 | 28 | 45 | B |
| Example 348 | A-62 | 77 | 28 | 45 | A |
| Example 349 | A-63 | 77 | 28 | 45 | D |
| Example 350 | A-64 | 77 | 28 | 45 | C |
| Example 351 | A-65 | 77 | 28 | 45 | B |
| Example 352 | A-66 | 77 | 28 | 45 | C |
| Example 353 | A-67 | 77 | 28 | 45 | B |
| Example 354 | A-68 | 77 | 28 | 45 | A |
| Example 355 | A-69 | 77 | 28 | 45 | D |
| Example 356 | A-70 | 77 | 28 | 45 | C |
| Example 357 | A-71 | 77 | 28 | 45 | B |
| Example 358 | A-72 | 77 | 28 | 45 | C |
| Example 359 | A-73 | 77 | 28 | 45 | B |
| Example 360 | A-74 | 77 | 28 | 45 | A |

TABLE 16

| | Electro- | Cleaning blade | | | |
|---|---|---|---|---|---|
| | photographic | | Contact | Contact | |
| | photosensitive | Hardness | angle | pressure | Results of |
| | member | [°] | [°] | [g/cm] | evaluation |
| Example 361 | A-75 | 77 | 28 | 45 | D |
| Example 362 | A-76 | 77 | 28 | 45 | C |
| Example 363 | A-77 | 77 | 28 | 45 | B |
| Example 364 | A-78 | 77 | 28 | 45 | C |
| Example 365 | A-79 | 77 | 28 | 45 | B |
| Example 366 | A-80 | 77 | 28 | 45 | A |
| Example 367 | B-9 | 77 | 28 | 30 | A |
| Example 368 | B-9 | 65 | 28 | 30 | A |
| Example 369 | B-9 | 80 | 28 | 30 | A |
| Example 370 | B-10 | 77 | 28 | 30 | A |
| Example 371 | B-10 | 65 | 28 | 30 | A |
| Example 372 | B-10 | 80 | 28 | 30 | A |
| Example 373 | B-9 | 77 | 28 | 15 | A |
| Example 374 | B-9 | 65 | 28 | 15 | A |
| Example 375 | B-9 | 80 | 28 | 15 | A |
| Example 376 | B-10 | 77 | 28 | 15 | A |
| Example 377 | B-10 | 65 | 28 | 15 | A |
| Example 378 | B-10 | 80 | 28 | 15 | A |
| Example 379 | B-9 | 77 | 28 | 45 | A |
| Example 380 | B-9 | 65 | 28 | 45 | A |
| Example 381 | B-9 | 80 | 28 | 45 | A |
| Example 382 | B-10 | 77 | 28 | 45 | A |
| Example 383 | B-10 | 65 | 28 | 45 | A |
| Example 384 | B-10 | 80 | 28 | 45 | A |

TABLE 17

| | Electro- | | | | |
|---|---|---|---|---|---|
| | photographic | Cleaning blade | | | |
| | photo- | | Contact | Contact | |
| | sensitive | Hardness | angle | pressure | Results of |
| | member | [°] | [°] | [g/cm] | evaluation |
| Example 1001 | A-5 | 77 | 24 | 30 | A |
| Example 1002 | B-1 | 77 | 24 | 30 | A |
| Example 1003 | A-5 | 65 | 24 | 30 | A |
| Example 1004 | B-1 | 65 | 24 | 30 | A |
| Example 1005 | A-5 | 80 | 24 | 30 | A |
| Example 1006 | B-1 | 80 | 24 | 30 | A |
| Example 1007 | B-1 | 77 | 24 | 20 | A |
| Example 1008 | B-1 | 77 | 24 | 45 | A |
| Example 1009 | A-5 | 77 | 24 | 15 | A |
| Example 1010 | A-5 | 65 | 24 | 15 | A |
| Example 1011 | A-5 | 80 | 24 | 15 | A |
| Example 1012 | A-5 | 77 | 24 | 45 | A |
| Example 1013 | A-5 | 65 | 24 | 45 | A |
| Example 1014 | A-5 | 80 | 24 | 45 | A |
| Example 1015 | B-1 | 77 | 24 | 15 | A |
| Example 1016 | B-1 | 65 | 24 | 15 | A |
| Example 1017 | B-1 | 80 | 24 | 15 | A |
| Example 1018 | B-1 | 77 | 24 | 45 | A |
| Example 1019 | B-1 | 65 | 24 | 45 | A |
| Example 1020 | B-1 | 80 | 24 | 45 | A |

TABLE 18

| | Electro- | | | | |
|---|---|---|---|---|---|
| | photographic | Cleaning blade | | | |
| | photo- | | Contact | Contact | |
| | sensitive | Hardness | angle | pressure | Results of |
| | member | [°] | [°] | [g/cm] | evaluation |
| Example 2001 | A-24 | 70 | 22 | 85 | A |
| Example 2002 | A-24 | 65 | 22 | 85 | A |
| Example 2003 | A-24 | 80 | 22 | 85 | A |
| Example 2004 | A-24 | 70 | 22 | 50 | A |
| Example 2005 | B-7 | 70 | 22 | 85 | A |
| Example 2006 | B-7 | 65 | 22 | 85 | A |
| Example 2007 | B-7 | 80 | 22 | 85 | A |
| Example 2008 | A-24 | 70 | 22 | 40 | A |
| Example 2009 | A-24 | 65 | 22 | 40 | A |
| Example 2010 | A-24 | 80 | 22 | 40 | A |
| Example 2011 | A-24 | 70 | 22 | 70 | A |
| Example 2012 | A-24 | 65 | 22 | 70 | A |
| Example 2013 | A-24 | 80 | 22 | 70 | A |
| Example 2014 | B-7 | 70 | 22 | 40 | A |
| Example 2015 | B-7 | 65 | 22 | 40 | A |
| Example 2016 | B-7 | 80 | 22 | 40 | A |
| Example 2017 | B-7 | 70 | 22 | 70 | A |
| Example 2018 | B-7 | 65 | 22 | 70 | A |
| Example 2019 | B-7 | 80 | 22 | 70 | A |

TABLE 19

| | Electro- | | | | |
|---|---|---|---|---|---|
| | photographic | Cleaning blade | | | |
| | photo- | | Contact | Contact | |
| | sensitive | Hardness | angle | pressure | Results of |
| | member | [°] | [°] | [g/cm] | evaluation |
| Example 3001 | A-27 | 70 | 24 | 70 | A |
| Example 3002 | A-27 | 65 | 24 | 70 | A |
| Example 3003 | A-27 | 80 | 24 | 70 | A |
| Example 3004 | A-27 | 70 | 24 | 45 | A |
| Example 3005 | A-27 | 65 | 24 | 45 | A |
| Example 3006 | A-27 | 80 | 24 | 45 | A |
| Example 3007 | A-27 | 70 | 24 | 60 | A |
| Example 3008 | A-27 | 65 | 24 | 60 | A |
| Example 3009 | A-27 | 80 | 24 | 60 | A |

(Production Example of Photosensitive Member E-1)

A conductive layer, an subbing layer, a charge-generating layer, a charge-transport layer, and a second charge-transport layer (protective layer) were formed on the support in the same manner as in Photosensitive member A-1 to produce an electrophotographic photosensitive member before formation of the depressed portion.

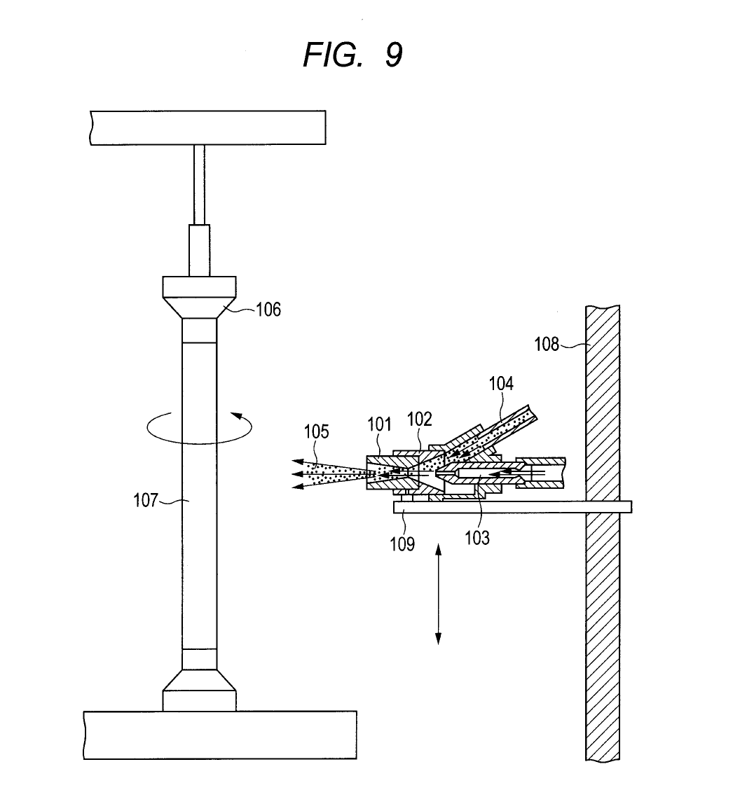

Next, using a dry blasting apparatus having a configuration generally illustrated in FIG. 9, dry blasting was performed to form a plurality of dimple-like depressed portions all over the surface (circumferential surface) of the electrophotographic photosensitive member. FIG. 9 illustrates an injection nozzle 101 for injecting particles (polishing particles) 105, a nozzle fixing jig 102 for fixing the injection nozzle 101, an introduction path 103 for air (compressed air), a path 104 for guiding the particles (polishing particles) 105 stored in a container to the injection nozzle 101, the particles (polishing particles) 105, a work supporting member 106 for supporting a work 107, the work 107 (the electrophotographic photosensitive member of interest in which the depressed portions are formed on the surface), an injection nozzle supporting member 108 for supporting the injection nozzle 101, and an injection nozzle fixing jig 109 for fixing the injection nozzle 101.

Thus, an electrophotographic photosensitive member having the depressed portions on the surface thereof was produced. The electrophotographic photosensitive member is referred to as “Photosensitive member E-1.”

Condition of Dry Blasting

Particles (polishing particles): spherical glass beads having the average particle diameter of 30 μm (trade name: UB-01L, made by Union K.K.)

Pressure of air (compressed air) to be blasted: 0.343 MPa (3.5 kgf/cm²)

Injection nozzle moving rate: 430 mm/s (the direction of the vertical arrow in FIG. 9)

Revolving rate of work: 288 rpm (the direction of the circular arrow in FIG. 9)

Distance between the ejection port of the injection nozzle and the work: 100 mm

Angle of the particles (polishing particles) to be ejected: 90°

Amount of particles (polishing particles) to be supplied: 200 g/min

The number of blasting: one way×twice

After the dry blasting, the particles (polishing particles) that remain and adhere onto the circumferential surface of the work were removed by blowing the compressed air.

The surface of the obtained electrophotographic photosensitive member was observed in the same manner as in Production Example of Photosensitive member A-1. The results are shown in Table 20.

(Production Examples of Photosensitive Members E-2 to E-9 and E-17)

Each electrophotographic photosensitive member was produced in the same manner as in Production Example of Photosensitive member A-1 except that instead of the mold used in Production Example of Photosensitive member A-1, a mold shown in Table 20 was used as the mold, and the temperatures of the electrophotographic photosensitive member and the mold were controlled such that the temperature of the surface of the electrophotographic photosensitive member was the temperature shown in Table 20 during the processing. The obtained electrophotographic photosensitive members having the depressed portions on the surface thereof are referred to as “Photosensitive member E-2” to “Photosensitive member E-9” and “Photosensitive member E-17.”

The surface of each electrophotographic photosensitive member obtained was observed in the same manner as in Production Example of Photosensitive member A-1. The results are shown in Table 20.

(Production Examples of Photosensitive Members E-10 and E-11)

Each electrophotographic photosensitive member was produced in the same manner as in Production Example of Photosensitive member A-5 except that instead of the mold used in Production Example of Photosensitive member A-5, a mold shown in Table 20 was used as the mold, and the temperatures of the electrophotographic photosensitive member and the mold were controlled such that the temperature of the surface of the electrophotographic photosensitive member was the temperature shown in Table 20 during the processing. The obtained electrophotographic photosensitive members having the depressed portions on the surface thereof are referred to as “Photosensitive member E-10” and “Photosensitive member E-11.”

The surface of each electrophotographic photosensitive member obtained was observed in the same manner as in Production Example of Photosensitive member A-1. The results are shown in Table 20.

(Production Examples of Photosensitive Members E-12 and E-13)

Each electrophotographic photosensitive member was produced in the same manner as in Production Example of Photosensitive member A-24 except that instead of the mold used in Production Example of Photosensitive member A-24, the mold shown in Table 20 was used as the mold, and the temperatures of the electrophotographic photosensitive member and the mold were controlled such that the temperature of the surface of the electrophotographic photosensitive member was the temperature shown in Table 20 during the processing. The obtained electrophotographic photosensitive members having the depressed portions on the surface thereof are referred to as “Photosensitive member E-12” and “Photosensitive Member E-13.”

The surface of each electrophotographic photosensitive member obtained was observed in the same manner as in Production Example of Photosensitive member A-1. The results are shown in Table 20.

(Production Examples of Photosensitive Members E-14 and E-15)

Each electrophotographic photosensitive member was produced in the same manner as in Production Example of Photosensitive member A-27 except that instead of the mold used in Production Example of Photosensitive member A-27, a mold shown in Table 20 was used as the mold, and the temperatures of the electrophotographic photosensitive member and the mold were controlled such that the temperature of the surface of the electrophotographic photosensitive member was the temperature shown in Table 20 during the processing. The obtained electrophotographic photosensitive members having the depressed portions on the surface thereof are referred to as “Photosensitive member E-14” and “Photosensitive member E-15.”

The surface of each electrophotographic photosensitive member obtained was observed in the same manner as in Production Example of Photosensitive member A-1. The results are shown in Table 20.

(Production Example of Photosensitive Member E-16)

A conductive layer, a subbing layer, a charge-generating layer, a charge-transport layer, and a second charge-transport layer (protective layer) were formed on the support in the same manner as in Photosensitive member A-1 to produce an electrophotographic photosensitive member having no depressed portion on the surface thereof. The electrophotographic photosensitive member is referred to as “Photosensitive member E-16.”

The surface of the obtained electrophotographic photosensitive member was observed in the same manner as in Production Example of Photosensitive member A-1. The results are shown in Table 20.

(Production Examples of Photosensitive Members E-18 to E-25)

Each electrophotographic photosensitive member was produced in the same manner as in Production Example of Photosensitive member A-1 except that instead of the mold used in Production Example of Photosensitive member A-1, a mold shown in Table 20 was used as the mold; the temperatures of the electrophotographic photosensitive member and the mold were controlled such that the temperature of the surface of the electrophotographic photosensitive member was the temperature shown in Table 20 during the processing; and while the electrophotographic photosensitive member was pressed against the pressurizing member at a pressure of 2.5 MPa, the electrophotographic photosensitive member was rotated in the circumferential direction to form the depressed portions all over the surface (circumferential surface) of the electrophotographic photosensitive member. The obtained electrophotographic photosensitive members having the depressed portions on the surface thereof are referred to as “Photosensitive member E-18” to “Photosensitive member E-25.”

The surface of each electrophotographic photosensitive member obtained was observed in the same manner as in Production Example of Photosensitive member A-1. The results are shown in Table 20.

(Production Example of Photosensitive Member E-26)

A conductive layer, a subbing layer, a charge-generating layer, and a charge-transport layer were formed on the support in the same manner as in Photosensitive member A-1.

Next, 1.5 parts of acrylic polyol (trade name: JONCRYL-587, made by Johnson Polymers Ltd.), 2.1 parts of a melamine resin (trade name: CYMEL-303, made by Cytec Industries Inc.), 1.16 parts of N,N,N′,N′-tetrakis-[(4-hydroxymethyl)phenyl]-biphenyl-4,4′-diamine(THM-TBD)/1.93 parts of N,N′-diphenyl-N,N′-di(3-hydroxyphenyl)-terphenyl-diamine (DHTER) as a charge transport component, and 0.05 parts of an acid catalyst (trade name: Nacure 5225, made by King Chemical Industries Inc.) were dissolved in 20.9 parts of 1-methoxy-2-propanol to prepare a coating solution for a second charge-transport layer (protective layer). The coating solution for a second charge-transport layer was applied onto the charge-transport layer by dip coating. Before the obtained coating film was cured, using the mold shown in Table 20, the shape of the mold was transferred onto the surface of the coating film in the state where the surface temperature of the coating film was kept at normal temperature (25° C.). Next, the coating film was thermally cured for 40 minutes at 140° C. to form a second charge-transport layer (protective layer) having a film thickness of 6 μm.

Thus, an electrophotographic photosensitive member having the depressed portions on the surface thereof was produced. The electrophotographic photosensitive member is referred to as “Photosensitive member E-26.”

The surface of the obtained electrophotographic photosensitive member was observed in the same manner as in Production Example of Photosensitive member A-1. The results are shown in Table 20.

TABLE 20

| | | | | Surface of electrophotographic photosensitive member | | | | | | |
|---|---|---|---|---|---|---|---|---|---|---|
| Electro- | Mold | | | | Area of | | Opening longest | Depth of | | |
| photographic | Longest | | | Temperature | specific | Area of | diameter of | specific | Proportion | Standard |
| photo- | diameter | Distance | Height | during | depressed | flat | specific depressed | depressed | of area of | deviation |
| sensitive | (Xm) | (Y1, Y2) | (H) | processing | portion | part | portion | portion | narrow area | of S |
| member | [μm] | [μm] | [μm] | [° C.] | [μm²] | [μm²] | [μm] | [μm] | [%] | [%] |
| E-1 | — | — | — | — | 180000 | 40000 | 40 | 2 | — | — |
| E-2 | 50 | 263, 263 | 2 | 140 | 5000 | 240000 | 50 | 2 | 5 | 1 |
| E-3 | 15 | 19, 19 | 2 | 140 | 40000 | 180000 | 15 | 2 | 10 | 1 |
| E-4 | 90 | 116, 140 | 2 | 140 | 40000 | 180000 | 90 | 2 | 10 | 1 |
| E-5 | 20 | 105, 120 | 2 | 140 | 5000 | 240000 | 20 | 2 | 5 | 1 |
| E-6 | 5 | 26, 31 | 2 | 140 | 5000 | 240000 | 5 | 2 | 5 | 1 |
| E-7 | 50 | 18, 26 | 2 | 140 | 110000 | 50000 | 50 | 2 | 100 | — |
| E-8 | 5 | 2, 2 | 2 | 140 | 100000 | 50000 | 5 | 1 | 100 | — |
| E-9 | 50 | 64, 77 | 1 | 140 | 40000 | 180000 | 50 | 0.2 | 10 | 1 |
| E-10 | 50 | 263, 300 | 2 | 140 | 5000 | 240000 | 50 | 2 | 5 | 1 |
| E-11 | 50 | 18, 26 | 2 | 140 | 110000 | 50000 | 50 | 2 | 100 | — |
| E-12 | 50 | 263, 300 | 2 | 140 | 5000 | 240000 | 50 | 2 | 5 | 1 |
| E-13 | 50 | 18, 26 | 2 | 140 | 110000 | 50000 | 50 | 2 | 100 | — |
| E-14 | 50 | 263, 300 | 2 | 140 | 5000 | 240000 | 50 | 2 | 5 | 1 |
| E-15 | 50 | 18, 26 | 2 | 140 | 110000 | 50000 | 50 | 2 | 100 | — |
| E-16 | — | — | — | — | 0 | 250000 | — | — | 0 | — |
| E-17 | 50 | 64, 77 | 8 | 140 | 40000 | 180000 | 50 | 7 | 10 | 1 |
| E-18 | 15 | 87, 99 | 1 | 140 | 4000 | 70000 | 15 | 0.3 | 40 | 10 |
| E-19 | 15 | 87, 99 | 7 | 140 | 4000 | 70000 | 15 | 6 | 40 | 10 |
| E-20 | 90 | 522, 594 | 1 | 140 | 4000 | 70000 | 90 | 0.3 | 40 | 10 |
| E-21 | 90 | 522, 594 | 7 | 140 | 4000 | 70000 | 90 | 6 | 40 | 10 |
| E-22 | 15 | 7, 10 | 1 | 140 | 90000 | 70000 | 15 | 0.3 | 40 | 10 |
| E-23 | 15 | 7, 10 | 7 | 140 | 90000 | 70000 | 15 | 6 | 40 | 10 |
| E-24 | 90 | 45, 61 | 1 | 140 | 90000 | 70000 | 90 | 0.3 | 40 | 10 |
| E-25 | 90 | 45, 61 | 7 | 140 | 90000 | 70000 | 90 | 6 | 40 | 10 |
| E-26 | 40 | 60, 60 | 10 | 23 | 40000 | 60000 | 40 | 1 | 45 | 7 |

### Comparative Examples 1 to 25

The electrophotographic photosensitive members were evaluated in the same manner as in Example 1 by the actual machine except that those shown in Table 21 were used as the electrophotographic photosensitive members, and the hardness and setting (the abut angle and the abut pressure) of the cleaning blade were as shown in Table 21. The results are shown in Table 21.

### Comparative Examples 26 and 27

The electrophotographic photosensitive members were evaluated in the same manner as in Example 1001 by the actual machine except that those shown in Table 21 were used as the electrophotographic photosensitive members, and the hardness and setting (the abut angle and the abut pressure) of the cleaning blade were as shown in Table 21. The results are shown in Table 21.

### Comparative Examples 28 and 29

The electrophotographic photosensitive members were evaluated in the same manner as in Example 2001 by the actual machine except that those shown in Table 21 were used as the electrophotographic photosensitive members, and the hardness and setting (the abut angle and the abut pressure) of the cleaning blade were as shown in Table 21. The results are shown in Table 21.

### Comparative Examples 30 and 31

The electrophotographic photosensitive members were evaluated in the same manner as in Example 3001 by the actual machine except that those shown in Table 21 were used as the electrophotographic photosensitive members, and the hardness and setting (the abut angle and the abut pressure) of the cleaning blade were as shown in Table 21. The results are shown in Table 21.

### Comparative Examples 32 to 85

The electrophotographic photosensitive members were evaluated in the same manner as in Example 1 by the actual machine except that those shown in Tables 21 to 23 were used as the electrophotographic photosensitive members, and the hardness and setting (the abut angle and the abut pressure) of the cleaning blade were as shown in Tables 21 to 23. The results are shown in Tables 21 to 23.

TABLE 21

| | | Cleaning blade | | | |
|---|---|---|---|---|---|
| | | | Contact | Contact | |
| | Electrophotographic | Hardness | angle | pressure | Results of |
| | photosensitive member | [°] | [°] | [g/cm] | evaluation |
| Comparative Example 1 | E-1 | 77 | 28 | 30 | E |
| Comparative Example 2 | E-2 | 77 | 28 | 30 | E |
| Comparative Example 3 | E-3 | 77 | 28 | 30 | E |
| Comparative Example 4 | E-4 | 77 | 28 | 30 | E |
| Comparative Example 5 | E-5 | 77 | 28 | 30 | E |
| Comparative Example 6 | E-6 | 77 | 28 | 30 | E |
| Comparative Example 7 | E-7 | 77 | 28 | 30 | E |
| Comparative Example 8 | E-8 | 77 | 28 | 30 | E |
| Comparative Example 9 | E-9 | 77 | 28 | 30 | E |
| Comparative Example 10 | E-10 | 77 | 28 | 30 | E |
| Comparative Example 11 | E-11 | 77 | 28 | 30 | E |
| Comparative Example 12 | E-12 | 65 | 28 | 30 | E |
| Comparative Example 13 | E-13 | 65 | 28 | 30 | E |
| Comparative Example 14 | E-14 | 65 | 28 | 30 | E |
| Comparative Example 15 | E-15 | 65 | 28 | 30 | E |
| Comparative Example 16 | E-16 | 65 | 28 | 30 | E |
| Comparative Example 17 | E-17 | 65 | 28 | 30 | E |
| Comparative Example 18 | E-2 | 80 | 28 | 30 | E |
| Comparative Example 19 | E-3 | 80 | 28 | 30 | E |
| Comparative Example 20 | E-4 | 80 | 28 | 30 | E |
| Comparative Example 21 | E-7 | 80 | 28 | 30 | E |
| Comparative Example 22 | E-16 | 80 | 28 | 30 | E |
| Comparative Example 23 | E-17 | 80 | 28 | 30 | E |
| Comparative Example 24 | E-2 | 77 | 28 | 15 | E |
| Comparative Example 25 | E-2 | 77 | 28 | 45 | E |
| Comparative Example 26 | E-10 | 77 | 24 | 30 | E |
| Comparative Example 27 | E-11 | 77 | 24 | 30 | E |
| Comparative Example 28 | E-12 | 77 | 22 | 85 | E |
| Comparative Example 29 | E-13 | 77 | 22 | 85 | E |
| Comparative Example 30 | E-14 | 77 | 24 | 70 | E |
| Comparative Example 31 | E-15 | 77 | 24 | 70 | E |
| Comparative Example 32 | E-18 | 77 | 28 | 15 | E |
| Comparative Example 33 | E-19 | 77 | 28 | 15 | E |
| Comparative Example 34 | E-20 | 77 | 28 | 15 | E |
| Comparative Example 35 | E-21 | 77 | 28 | 15 | E |
| Comparative Example 36 | E-22 | 77 | 28 | 15 | E |
| Comparative Example 37 | E-23 | 77 | 28 | 15 | E |
| Comparative Example 38 | E-24 | 77 | 28 | 15 | E |
| Comparative Example 39 | E-25 | 77 | 28 | 15 | E |
| Comparative Example 40 | E-26 | 77 | 28 | 15 | E |

TABLE 22

| | | Cleaning blade | | | |
|---|---|---|---|---|---|
| | | | Contact | Contact | |
| | Electrophotographic | Hardness | angle | pressure | Results of |
| | photosensitive member | [°] | [°] | [g/cm] | evaluation |
| Comparative Example 41 | E-18 | 65 | 28 | 15 | E |
| Comparative Example 42 | E-19 | 65 | 28 | 15 | E |
| Comparative Example 43 | E-20 | 65 | 28 | 15 | E |
| Comparative Example 44 | E-21 | 65 | 28 | 15 | E |
| Comparative Example 45 | E-22 | 65 | 28 | 15 | E |
| Comparative Example 46 | E-23 | 65 | 28 | 15 | E |
| Comparative Example 47 | E-24 | 65 | 28 | 15 | E |
| Comparative Example 48 | E-25 | 65 | 28 | 15 | E |
| Comparative Example 49 | E-26 | 65 | 28 | 15 | E |
| Comparative Example 50 | E-18 | 80 | 28 | 15 | E |
| Comparative Example 51 | E-19 | 80 | 28 | 15 | E |
| Comparative Example 52 | E-20 | 80 | 28 | 15 | E |
| Comparative Example 53 | E-21 | 80 | 28 | 15 | E |
| Comparative Example 54 | E-22 | 80 | 28 | 15 | E |
| Comparative Example 55 | E-23 | 80 | 28 | 15 | E |
| Comparative Example 56 | E-24 | 80 | 28 | 15 | E |
| Comparative Example 57 | E-25 | 80 | 28 | 15 | E |
| Comparative Example 58 | E-26 | 80 | 28 | 15 | E |
| Comparative Example 59 | E-18 | 77 | 28 | 45 | E |
| Comparative Example 60 | E-19 | 77 | 28 | 45 | E |
| Comparative Example 61 | E-20 | 77 | 28 | 45 | E |
| Comparative Example 62 | E-21 | 77 | 28 | 45 | E |
| Comparative Example 63 | E-22 | 77 | 28 | 45 | E |
| Comparative Example 64 | E-23 | 77 | 28 | 45 | E |
| Comparative Example 65 | E-24 | 77 | 28 | 45 | E |
| Comparative Example 66 | E-25 | 77 | 28 | 45 | E |
| Comparative Example 67 | E-26 | 77 | 28 | 45 | E |
| Comparative Example 68 | E-18 | 65 | 28 | 45 | E |
| Comparative Example 69 | E-19 | 65 | 28 | 45 | E |
| Comparative Example 70 | E-20 | 65 | 28 | 45 | E |
| Comparative Example 71 | E-21 | 65 | 28 | 45 | E |
| Comparative Example 72 | E-22 | 65 | 28 | 45 | E |
| Comparative Example 73 | E-23 | 65 | 28 | 45 | E |
| Comparative Example 74 | E-24 | 65 | 28 | 45 | E |
| Comparative Example 75 | E-25 | 65 | 28 | 45 | E |
| Comparative Example 76 | E-26 | 65 | 28 | 45 | E |
| Comparative Example 77 | E-18 | 80 | 28 | 45 | E |
| Comparative Example 78 | E-19 | 80 | 28 | 45 | E |
| Comparative Example 79 | E-20 | 80 | 28 | 45 | E |
| Comparative Example 80 | E-21 | 80 | 28 | 45 | E |

TABLE 23

| | Electro- | Cleaning blade | | | |
|---|---|---|---|---|---|
| | photographic | | Contact | Contact | |
| | photosensitive | Hardness | angle | pressure | Results of |
| | member | [°] | [°] | [g/cm] | evaluation |
| Comparative | E-22 | 80 | 28 | 45 | E |
| Example 81 | | | | | |
| Comparative | E-23 | 80 | 28 | 45 | E |
| Example 82 | | | | | |
| Comparative | E-24 | 80 | 28 | 45 | E |
| Example 83 | | | | | |
| Comparative | E-25 | 80 | 28 | 45 | E |
| Example 84 | | | | | |
| Comparative | E-26 | 80 | 28 | 45 | E |
| Example 85 | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-122748, filed May 31, 2011, Japanese Patent Application No. 2012-043118, filed Feb. 29, 2012, PCT International Application No. PCT/JP2012/056046, filed Mar. 2, 2012, and Japanese Patent Application No. 2012-118554 filed May 24, 2012, which are hereby incorporated by reference herein in their entirety.

1. An electrophotographic photosensitive member, comprising a support and a photosensitive layer formed on the support, wherein
a surface of the electrophotographic photosensitive member comprises a plurality of depressed portions and a portion other than the depressed portions, each of the depressed portions having a depth of 0.5 to 5 μm and an opening longest diameter of 20 to 80 μm, and
when a 500 μm×500 μm square region is disposed in an arbitrary position of the surface of the electrophotographic photosensitive member, an area of the depressed portions in the 500 μm×500 μm square region is from 10000 to 90000 μm², and an area of a flat part contained in the portion other than the depressed portions is from 80000 to 240000 μm².

2. The electrophotographic photosensitive member according to claim 1, wherein a proportion of an area of a narrow area, in which a 10 μm×10 μm square region cannot be disposed, of the flat part in the 500 μm×500 μm square region is not more than 30% based on a total area of the flat part in the 500 μm×500 μm square region.

3. The electrophotographic photosensitive member according to claim 2, wherein when the proportion of the area of the narrow area is measured in each of the 500 μm×500 μm square regions disposed in arbitrary 50 positions of the surface of electrophotographic photosensitive member, a standard deviation of the 50 measured values is not more than 5%.

4. An electrophotographic photosensitive member, comprising a support and a photosensitive layer formed on the support, wherein
at least a contact area with a cleaning member of a surface of the electrophotographic photosensitive member comprises a plurality of depressed portions and a portion other than the depressed portions, each of the depressed portions having a depth of 0.5 to 5 μm and an opening longest diameter 20 to 80 μm, and
when a 500 μm×500 μm square region is disposed in an arbitrary position of the contact area with the cleaning member, an area of the depressed portions in the 500 μm×500 μm square region is from 10000 to 90000 μm², and an area of a flat part contained in the portion other than the depressed portions is from 80000 to 240000 μm².

5. The electrophotographic photosensitive member according to claim 4, wherein a proportion of an area of a narrow area, in which a 10 μm×10 μm square region cannot be disposed, of the flat part in the 500 μm×500 μm square region is not more than 30% based on a total area of the flat part in the 500 μm×500 μm square region.

6. The electrophotographic photosensitive member according to claim 5, wherein when the proportion of the area of the narrow area is measured in each of the 500 μm×500 μm square regions disposed in arbitrary 50 positions of the contact area with the cleaning member, a standard deviation of the 50 measured values is not more than 5%.

7. A process cartridge, being detachably attachable to a main body of an electrophotographic apparatus, and integrally supporting:
the electrophotographic photosensitive member according to claim 1, and
a cleaning unit having a cleaning member disposed in contact with the electrophotographic photosensitive member.

8. An electrophotographic apparatus, comprising:
an electrophotographic photosensitive member according to claim 1,
a charging unit,
an exposure unit,
a developing unit,
a transfer unit, and
a cleaning unit having a cleaning member disposed in contact with the electrophotographic photosensitive member.
